(19) United States
(12) Patent Application Publication
(10) Pub. No.: US 2014/0220463 A1
(43) Pub. Date: Aug. 7, 2014

(54) PRESSURE FEED FLOW BATTERY SYSTEM AND METHOD

(71) Applicant: Ashlawn Energy, LLC, Alexandria, VA (US)

(72) Inventor: Maurice DANIEL, Alexandria, VA (US)

(73) Assignee: Ashlawn Energy, LLC, Alexandria, VA (US)

(21) Appl. No.: 14/169,743

(22) Filed: Jan. 31, 2014

Related U.S. Application Data
(60) Provisional application No. 61/849,706, filed on Feb. 1, 2013.

(51) Int. Cl. H01M 8/04; H01M 8/20; H01M 8/18

(52) U.S. Cl. CPC H01M 8/04276; H01M 8/188; H01M 8/20
USPC 429/415

(57) ABSTRACT

A flow battery system and method are provided. The flow battery system includes a first battery stack including a first half-cell, a first pressure feed system, including at least a first storage tank and a first booster tank to store a liquid electrolyte, designed to generate a first booster pressure in the first booster tank sufficient to force the liquid electrolyte to be fed from the first pressure feed system through the first half-cell, and a return system to return the liquid electrolyte from the first half-cell to the first pressure feed system. The return system may include a gravity feed system returning liquid electrolyte from the first half-cell to a collection tank, and a pump to return the collected liquid electrolyte from the collection tank to the first storage tank. The pressure feed flow battery system may have a two-tank, divided 2-tank, or four-tank flow battery configurations.

### CROSS-REFERENCE TO RELATED APPLICATIONS

This application claims the benefit of U.S. Provisional Application No. 61/849,706, filed Feb. 1, 2013, in the United States Patent and Trademark Office, the disclosure of which is incorporated herein by reference.

### BACKGROUND

1. Field

One or more embodiments related to a flow battery system having a pressure feed system, and more particularly, to a flow battery system having a pressure feed system that uses a booster tank to generate sufficient head pressure at a battery stack to force electrolyte through the battery stack for charging or discharging the flow battery system.

2. Description of the Related Art

Reduction-oxidation (redox) flow batteries, also known as regenerative fuel cells, or reversible fuel cells, or secondary fuel cells, are a type of storage battery having two liquid electrolytes; a positive electrolyte or catholyte, and a negative electrolyte or anolyte.

The two electrolytes are typically separated from one another in a battery stack by an ion exchange membrane. In this type of battery the two electrodes are typically inert and primarily serve to collect or distribute the electric charge from the battery cell(s). The membrane may divide the battery stack into two half-cells, for example. Here, each half-cell may generally be made up of a rectangular frame with a central rectangular cavity, with the membrane being stretched across one side of the frame and a conductive graphite plate serving as the electrode and extending across the other side of the frame. In such an arrangement, a rectangle of electrically conductive carbon felt may be cut to fit inside and fill the entire cavity of the half-cell to assist in collecting or distributing electric charge from the electrolyte. Positive electrolyte would fill the positive half-cell and negative electrolyte would fill the negative half-cell within the carbon felt. Both electrolytes are usually metal salts in an acid solution. For example in an iron/chrome couple redox flow battery the negative electrolyte contains iron ions and the positive electrolyte contains chromium ions, both dissolved in a hydrochloric acid solution. In a flow battery the positive and negative electrolyte solutions are stored in tanks external to the battery stack and pumps are typically used to feed the electrolytes through their respective half-cells during charging and discharging periods of operation.

In most conventional redox flow battery systems the electrolytes are drawn out of their storage tanks by pumps and injected into the bottom of a battery stack. Generally the pumps are electric powered and consume part of the flow battery's source of electricity, thus reducing the flow battery's over-all efficiency. The battery stacks are usually placed above the storage tanks so that the processed electrolyte emerging from the top of the battery stack can flow down, by gravity, back into their respective storage tanks. Otherwise, pumps are used to return the processed electrolytes back into their storage tanks.

FIG. 1 illustrates a pump-feed redox flow battery system with a battery stack elevated above storage tanks for gravity return. In this two-tank arrangement, positive electrolyte is stored in a storage tank 101 and negative electrolyte is stored in the another storage tank 121. Accordingly, the electrolytes 115 and 135 are drawn out of the bottoms of storage tanks 101 and 121 by the action of feed pumps 105 and 125. One-way valves 106 and 126, located just after the feed pumps 105 and 125, prevent flow-back of the electrolyte when the pump is turned off. Electrolyte is usually then forced through the bottom of the battery stack 104 and out the top of the battery stack 104. The battery stack 104 is located above the storage tanks 101 and 121 to allow for “gravity return” to direct the electrolyte fluid back into the storage tanks 101 using gravity. The electrolyte flows through pipes 107 and 127 into the top of the respective storage tanks 101 and 121 where it is then sprayed, or dripped, onto the top of the electrolyte contained in the tank after exiting the respective nozzle portions 117 and 137 of pipes 107 and 127. This spraying of electrolyte into the storage tanks 101 and 121 prevents an electrical circuit from being formed in the fluid loop thus reducing shunt current losses. Inert gases 114 and 134, such as nitrogen or argon, may be maintained at the top of the storage tanks 101 and 121 to prevent oxidation of the reactants. Some sort of snorkel mechanisms 108 and 128 may be placed at the top of the respective storage tanks 101 and 121 to allow equalization of the gas pressures 114 and 134 inside the storage tanks 101 and 121 to the ambient air outside the storage tanks 101 and 121. This standard arrangement allows for storage tanks 101 and 121 to be positioned at ground level and the elevated battery stack allows the processed electrolyte to flow back into the storage tanks 101 and 121 through gravity return, e.g., without additional return pumps.

In this arrangement, because the feed pumps 105 and 125 feed the respective electrolytes from the storage tanks 101 and 121 to the battery stack 104, a flow rate of respective electrolytes through the battery stack 104 is influenced by the feed pumping, and thus, the flow rate through the battery stack 104 would be subjected to fluctuations in pump performance.

Accordingly, having the pumps located between the storage tanks and the battery stack introduces pump induced fluttering in the fluid flow, pressure spikes when the pumps are turned on and off, pump-induced pressure differentials across the battery stack membranes, and pump induced turbulence in the electrolyte fluid flow. The wet and flaccid membranes of the battery stack instantly respond to these pressure differences resulting in mechanical stress to the membranes that over time will reduce their productive life. The turbulent flow causes increased fluid flow resistance in the battery stack(s), which in turn decreases pumping efficiency and increases pumping energy requirements.

A second method of circulating the electrolyte is to place the storage tanks higher than the battery stack and let gravity feed the electrolyte into the battery stack and use pumps to return the electrolytes from the battery stack back to the tanks, in an attempt to eliminate these problems. This second method, known as “gravity feed”, has been used in the laboratory to demonstrate such a flow battery concept, but these laboratory demonstrated concepts have not previously been reduced to practice in large flow batteries, such systems greater than tens of kilowatts to megawatts of electric energy. For example, in an example vanadium based electrolyte sulfuric acid solution, it may be necessary to elevate over 10 gallons of positive and negative electrolyte solution to store just one kilowatt of electric energy. Thus, in this example, to store just 10 kilowatts of electric energy it is necessary to elevate over 100 gallons of the sulfuric acidic solution at a height above the battery stack.

FIG. 2 illustrates such an experimental gravity feed flow battery with storage tanks elevated above a battery stack for gravity feed. In this arrangement, the storage tanks 201 and 221 are elevated and the battery stack 204 is near ground level, thus allowing the electrolytes to flow from the storage tanks 201 and 221 to the battery stack 204 by the action of gravity. Electrolytes 215 and 235 respectively contained in elevated storage tanks 201 and 221 flow out the bottom of the elevated storage tanks 201 and 221 through respective pipes 202 and 222 and into the bottom of the battery stack 204 after first passing through respective variable valves 203 and 223. After leaving the top of the battery stack 204 the electrolyte is pulled by return pumps 205 and 225 and returned through respective pipes 207 and 227 back to the tops of the elevated storage tanks 201 and 221. One-way valves 206 and 226 are positioned at appropriate positions along the respective flow path to prevent back-flow of the electrolyte. The return pipes 207 and 227 may be terminated by a nozzle, a drip pan, or other elements, such as the illustrated inner portions 217 and 237 of the return pipes 207 and 227, to return the fluid back into its reservoir in respective storage tanks 201 and 221 such that it does not form an electrical return path that would contribute to the shunt current system losses.

The maximum gravity feed pressure at the bottom of the battery stack 204 of FIG. 2 is determined by the height H. For example, when respective variable valves 203 and 223 are open, the respective hydrostatic pressure at an outlet of each of the storage tanks 201 and 221 can then be reflected as the gravity feed pressure or head pressure at the inlet of the battery stack 204. However, in this particular arrangement the respective return pumps 205 and 225 may also contribute suction on the electrolyte flow, which would increase the flow rate through the battery stack 204. Thus the flow rate through the battery stack 204 may be determined by the pressure differential between the initial gravity induced head pressure at the bottom of the battery stack 204, or inlet to the battery stack 204, and the pump induced suction at the top of the battery stack 204. It may be ideal that, after passing through the battery stack 204 (or plural battery stacks 204) over a height of h, resistance to the flow causes the fluid pressure to drop to near zero at the top of the battery stack 204 (or at the top of the last battery stack 204 when there are plural in-line battery stacks 204). In such an arrangement, at a minimum the pumps 205 and 225 would then pump the respective electrolyte from the top of the battery stack 204 to the top of the storage tanks 201 and 221 to overcome a height difference of H-h.

In this arrangement, because pumping is used to return the respective electrolytes to the storage tanks 201 and 221 and the flow rate through the battery stack 204 may be influenced by the return pumping, the flow rate through the battery stack 204 would still be subjected to fluctuations in pump performance, thus reducing the advantages of using gravity feed in this arrangement.

The gravity feed method of supplying electrolyte to a battery stack has several advantages over the conventional pump-fed method. First of all the gravity feed method can produce a very uniform laminar flow in the battery stack for better battery performance and efficiency. The efficiency is improved as the reduction in turbulence reduces pumping requirements, and thereby cuts the energy cost of operating the flow battery. A second advantage is in “black start” operations where the system must quickly respond to a power outage where external power is not available to operate the pumps.

The problem for a large battery using gravity feed is that this gravity feed flow battery approach typically requires thousands of gallons of acid in storage tanks to be placed at an elevated height, which would be both expensive and dangerous. These storage tanks may occasionally leak due to a variety of possible causes, including containment failures and natural disasters. Such accidental spills are made worse by above ground placement of the storage tanks, where leaking electrolyte acid could potentially rain down on workers trying to repair the leaking components. These cost and safety factors are one of the primary reasons that gravity feed is not used in large conventional redox flow batteries.

### SUMMARY

One or more embodiments provide a flow battery system including a first battery stack including a first half-cell utilizing a liquid electrolyte, a first pressure feed system, including at least a first storage tank and a first booster tank, designed to generate a first booster pressure in the first booster tank for the liquid electrolyte in the first booster tank sufficient to force the liquid electrolyte to be fed from the first pressure feed system through the first half-cell, and a return system to return the liquid electrolyte from the first half-cell to the first pressure feed system.

The first pressure feed system may feed the liquid electrolyte from the first booster tank to the first battery stack without using a pump.

The flow battery system may further include a controller to control the first booster pressure of the liquid electrolyte in the first booster tank to generate the sufficient first booster pressure in the first booster tank. The controller may control a transporting of the liquid electrolyte, having transported from the first storage tank, to the first booster tank, such that the controlling of the transporting of the liquid electrolyte to the first booster tank controls the first booster pressure of the liquid electrolyte in the first booster tank to generate the sufficient first booster pressure in the first booster tank.

The flow battery system may further include a pressure sensor configured to detect the first booster pressure of the liquid electrolyte in the first booster tank and the controller controls the transporting of the liquid electrolyte to the first booster tank based upon the detected first booster pressure. The first booster tank may include an inlet and the first pressure feed system further include a gas regulator to control an input of gas into the first booster tank through the inlet, wherein the controller controls the gas regulator and the transporting of the liquid electrolyte to the first booster tank based upon the detected first booster pressure so that pressure provided to the first booster tank by the transporting of the liquid electrolyte to the first booster tank and pressure provided by the input gas generate the sufficient first booster pressure. The controller may selectively adjust the generated sufficient first booster pressure based upon a determined electrolyte reactant imbalance. The flow battery system may further include a first booster tank pressure sensor to detect the first booster pressure, a temperature sensor in at least one of the first booster tank and the first storage tank, and a state of charge (SOC) detector to determine a state of charge of the electrolyte stored in at least one of the first booster tank and the first storage tank, and the controller may determine the sufficient first booster pressure based upon determined results of the first booster tank pressure sensor, the temperature sensor, and the state of charge detector to generate a desired electrolyte flow rate through the first battery stack.

The first booster tank may internally include a pressure altering regulator configured to alter pressure within the first booster tank, wherein the controller may control the pressure altering regulator and the transporting of the liquid electrolyte to the first booster tank based upon the detected first booster pressure to generate the sufficient first booster pressure. The controller may selectively adjust the generated sufficient first booster pressure based upon a determined electrolyte reactant imbalance.

The flow battery system may include a variable valve in a fluid transport path of the liquid electrolyte being fed from the first pressure feed system to the first battery stack, wherein the controller may control a variable opening of the variable valve to control a flow rate of the liquid electrolyte through the first battery stack when charging or discharging through battery cells of the first battery stack dependent on a determination of the first booster pressure.

The return system may include a gravity return system, such that the liquid electrolyte is fed into a first collection tank after having exited the first half-cell without using a pump and then selectively returned from the first collection tank to the first storage tank. The return system may further include a return pump to pump the liquid electrolyte from the first collection tank to the first storage tank.

The first pressure feed system may further include a first booster tank pump to pump the liquid electrolyte, having transported from the first storage tank, to the first booster tank. The flow battery system may further include a controller to control the first booster tank pump to pump the liquid electrolyte with a selectable pressure to generate the sufficient first booster pressure. The controller may control a pumping of the first booster tank pump to increase a pumping pressure of the liquid electrolyte, having transported from the first storage tank, when the controller determines that the first booster pressure in the first booster tank is below a predetermined pressure. The controller may control a pumping of the first booster tank pump to decease a pumping pressure of the liquid electrolyte, having transported from the first storage tank, when the controller determines that the first booster pressure in the first booster tank is above a predetermined pressure.

The sufficient first booster pressure may be a pressure inside the first booster tank that generates a head pressure at the first battery stack that is greater than a minimum head pressure needed to force the liquid electrolyte to be fed through the first battery stack.

A top of the first storage tank may be fitted with a snorkel configured to equalize pressures inside a top-most portion of the first storage tank with an atmospheric pressure existing outside the first storage tank. A top portion of the first booster tank may have an extended bulbous cavity above a electrolyte fluid level in the first booster tank for buffering changes in the first booster pressure in the first booster tank.

The flow battery may further include a second battery stack, including a second half-cell, at a height different from a height of the first battery stack, wherein the first pressure feed system further includes a second booster tank, designed to generate a second booster pressure in the second booster tank for the liquid electrolyte in the second booster tank sufficient to force the liquid electrolyte to be fed from the first pressure feed system through the second half-cell.

The first pressure feed system may feed the liquid electrolyte from the first booster tank to the first battery stack without using a pump, and feed the liquid electrolyte from the second booster tank to the second battery stack without using a pump. The flow battery system may further include a controller to control the first booster pressure in the first booster tank to generate the sufficient first booster pressure to force the liquid electrolyte to be fed from the first pressure feed system through the first half-cell when charging or discharging battery cells of the first battery stack, and to control the second booster pressure in the second booster tank to generate the sufficient second booster pressure to force the liquid electrolyte to be fed from the first pressure feed system through the second half-cell when charging or discharging battery cells of the second battery stack. The controlling of the first booster pressure in the first booster tank may include a controlling of a transporting of the liquid electrolyte, having transported from the first storage tank, to the first booster tank based upon a determination of the first booster pressure so as to generate the sufficient first booster pressure, and the controlling of the second booster pressure in the second booster tank may include a controlling of a transporting of the liquid electrolyte, having transported from the first storage tank, to the second booster tank based upon a determination of the second booster pressure so as to generate the sufficient second booster pressure.

The flow battery system may further include a first variable valve in a fluid transport path of the liquid electrolyte being fed from the first pressure feed system to the first battery stack, a second variable valve in a fluid transport path of the liquid electrolyte being fed from the first pressure feed system to the second battery stack, wherein the controller may control a variable opening of the first variable valve based on a determination of the first booster pressure and control a variable opening of the second variable valve based on a determination of the second booster pressure, to control respective flow rates of the liquid electrolyte through the first battery stack and the second battery stack when respectively charging or discharging.

The return system may include a gravity return system, such that the liquid electrolyte is fed into one or more storage collection tanks after having exited the first half-cell without using a pump and after having exited the second half-cell without using a pump, and wherein the return system is configured to return the liquid electrolyte in the one or more storage collection tanks to the first storage tank.

The first pressure feed system may further include a first booster tank pump to pump the liquid electrolyte from the first storage tank to the first booster tank to adjust the first booster pressure in the first booster tank based on a determination of the first booster pressure, to generate the sufficient first booster pressure, and a second booster tank pump to pump the liquid electrolyte from the first storage tank to the second booster tank to adjust the second booster pressure in the second booster tank based on a determination of the second booster pressure, to generate the sufficient first booster pressure. The controller may control the first booster tank pump to generate the sufficient first booster pressure based upon the determined first booster pressure, and controls the second booster tank pump to generate the sufficient second booster pressure based upon the determined second booster pressure.

The first booster tank and the second booster tank may be separate chambers of a single tank.

The flow battery system may further include a second battery stack, including a second half-cell, at a height different from a height of the first battery stack, wherein the first booster tank may include a first outlet and a second outlet at different heights of the first booster tank, such that the first pressure feed system generates the first booster pressure sufficient to force the liquid electrolyte to be fed out of the first booster tank through the first outlet and then through the first half-cell, and sufficient to force the liquid electrolyte to be fed out of the first booster tank through the second outlet and then through the second half-cell.

The first storage tank may be configured to separately store charged liquid electrolyte in a first portion of the first storage tank and depleted liquid electrolyte in a second first portion of the first storage tank, with the first portion and the second portion being dynamically defined based upon a variable movement of a separator of the first storage tank performing the separate storing of the charged liquid electrolyte and the depleted liquid electrolyte. The first pressure feed system may further include a second booster tank, and the first pressure feed system is designed to generate a second booster pressure in the second booster tank for the liquid electrolyte in the second booster tank sufficient to force the liquid electrolyte to be fed from the second pressure feed system through the first half-cell, wherein the first pressure feed system may be further configured to transport the charged liquid electrolyte to the first booster tank, having transported from the first portion of the first storage tank, and to transport the depleted liquid electrolyte to the second booster tank, having transported from the second portion of the first storage tank. The flow battery system may further include a charge/discharge selector valve in a fluid transport path of the charged liquid electrolyte being fed from the first booster tank to the first battery stack and in a fluid transport path of the depleted liquid electrolyte being fed from the second booster tank to the first battery stack, and a variable valve in a transport fluid path of the charged or depleted liquid electrolyte having passed the charge/discharge selector valve to the first battery stack, wherein the controller may control a respective variable opening of the variable valve to control a flow rate of the charged or depleted liquid electrolyte through the first battery stack when respectively charging or discharging, and control the charge/discharge valve to transport the charged liquid electrolyte from the first booster tank to the first battery stack when discharging the first battery stack and to transport the depleted liquid electrolyte from the second booster tank to the first battery stack when charging the first battery stack.

The flow battery system may further include a second pressure feed system including at least a second storage tank and second booster tank, such that the second pressure feed system is designed to generate a second booster pressure in the second booster tank for the liquid electrolyte in the second booster tank sufficient to force the liquid electrolyte to be fed from the second pressure feed system through the first half-cell. The liquid electrolyte stored by the first storage tank may be charged liquid electrolyte and the liquid electrolyte stored by the second storage tank may be depleted liquid electrolyte.

They flow battery system may further include controller to control a transporting of the charged liquid electrolyte from the first storage tank to the first booster tank to generate the sufficient first booster pressure in the first booster tank, to force the liquid electrolyte to be fed from the first pressure feed system through the first half-cell when discharging battery cells of the first battery stack, and to control a transporting of the depleted liquid electrolyte from the second storage tank to the second booster tank to generate the sufficient second booster pressure in the second booster tank, to force the liquid electrolyte to be fed from the second pressure feed system through the first half-cell when charging battery cells of the first battery stack. The flow battery system may further include a charge/discharge selector valve in a fluid transport path of the charged liquid electrolyte being fed from the first pressure feed system to the first battery stack and in a fluid transport path of the depleted liquid electrolyte being fed from the second pressure feed system to the first battery stack, and a variable valve in a transport fluid path of the charged or depleted liquid electrolyte having passed the charge/discharge selector valve to the first battery stack, wherein the controller may control a respective variable opening of the variable valve to control a flow rate of the charged or depleted liquid electrolyte through the first battery stack when respectively charging or discharging based on a determination of the first booster pressure or the second booster tank pressure, and control the charge/discharge valve to transport charged liquid electrolyte from the first pressure feed system to the first battery stack when discharging the first battery stack and to transport depleted liquid electrolyte from the second pressure feed system to the first battery stack when charging the first battery stack. The return system may include a gravity return system, such that the charged liquid electrolyte is selected to be fed into a first collection tank after having been charged and then exited the first half-cell without using a pump and then selectively returned from the first collection tank to the first storage tank, and the depleted liquid electrolyte is selected to be fed into a second collection tank after having been depleted and then exited the first half-cell without using a pump and then selectively returned from the second collection tank to the second storage tank.

The first pressure feed system may further include a first booster tank pump to pump charged liquid electrolyte from the first storage tank to the first booster tank to adjust the first booster pressure in the first booster tank based on a determination of the first booster pressure, wherein the second pressure feed system may further include a second booster tank pump to pump depleted liquid electrolyte from the second storage tank to the second booster tank to adjust the second booster pressure in the second booster tank based on a determination of the second booster pressure.

The flow battery system may further include a pressure equilibrium element connecting a gas space in the first storage tank and a gas space in the second storage tank, configured to perform equilibrium between an atmospheric pressure and the gas spaces in the first and second storage tanks.

The first booster tank and the second booster tank may be separate chambers of a single tank.

The sufficiency of the first booster pressure in the first booster tank, to force the liquid electrolyte to be fed through the first half-cell, may be based on a configuration of the first battery stack having an inlet fed the liquid electrolyte from the first pressure feed system and/or an outlet to return the liquid electrolyte to the return system be on lateral sides of the first battery stack. The sufficiency of the first booster pressure in the first booster tank, to force the liquid electrolyte to be fed through the first half-cell, may be based on a configuration of the first battery stack having an inlet fed the liquid electrolyte from the first pressure feed system and/or an outlet to return the liquid electrolyte to the return system be on top or bottom sides of the first battery stack.

One or more embodiments provide a flow battery system including a battery stack including a battery cell, half of the battery cell being a half-cell utilizing positive terminal liquid electrolyte and another half of the battery cell being a second half-cell utilizing a negative terminal liquid electrolyte, a first feed system, including at least a first storage tank for storing the positive terminal liquid electrolyte, designed to force the positive terminal liquid electrolyte to be fed from the first feed system through the first half-cell, a second feed system, including at least a second storage tank for storing the negative terminal liquid electrolyte, designed to force the negative terminal liquid electrolyte to be fed from the second feed system through the second half-cell, a first return system to return the positive terminal liquid electrolyte from the first half-cell to the first storage tank of the first pressure feed system, and a second return system to return the negative terminal liquid electrolyte from the second half-cell to the second storage tank of the first pressure feed system, wherein the first and second return systems include gravity return systems, such that the positive terminal liquid electrolyte is fed into a first collection tank after having exited the first half-cell without using a pump and then selectively returned from the first collection tank to the first storage tank, and the negative terminal liquid electrolyte is fed into a second collection tank after having exited the second half-cell without using a pump and then selectively returned from the second collection tank to the second storage tank.

One or more embodiments provide a flow battery system including a battery stack including a battery cell, half of the battery cell being a half-cell utilizing positive terminal liquid electrolyte and another half of the battery cell being a second half-cell utilizing a negative terminal liquid electrolyte, a first pressure feed system, including at least a first storage tank and a first booster tank for storing the positive terminal liquid electrolyte, designed to generate a first booster pressure in the first booster tank for the positive terminal liquid electrolyte in the first booster tank sufficient to force the positive terminal liquid electrolyte to be fed from the first booster tank through the first half-cell, a second pressure feed system, including at least a second storage tank and a second booster tank for storing the negative terminal liquid electrolyte, designed to generate a second booster pressure in the second booster tank for the negative terminal liquid electrolyte in the second booster tank sufficient to force the negative terminal liquid electrolyte to be fed from the second booster tank through the second half-cell, a first return system to return the positive terminal liquid electrolyte from the first half-cell to the first storage tank of the first pressure feed system, and a second return system to return the negative terminal liquid electrolyte from the second half-cell to the second storage tank of the first pressure feed system.

The first pressure feed system may feed the positive terminal liquid electrolyte from the first booster tank to the first half cell without using a pump, and the second pressure feed system may feed the negative terminal liquid electrolyte from the second booster tank to the second half cell without using a pump. The flow battery system may further include a controller to control the first booster pressure in the first booster tank to be the sufficient first booster pressure, by controlling a transporting pressure of the positive terminal liquid electrolyte from the first storage tank to the first booster tank, to force the positive terminal liquid electrolyte to be fed from the first booster tank through the first half-cell, and to control the second booster pressure in the second booster tank to be the sufficient second booster pressure, by controlling a transporting pressure of the negative terminal liquid electrolyte from the second storage tank to the second booster tank, to force the negative terminal liquid electrolyte to be fed from the second booster tank through the second half-cell. The sufficient first booster pressure may be equal to the sufficient second booster pressure.

The sufficient first booster pressure may be different from the sufficient second booster pressure, and the controller may control a flow rate of the positive terminal liquid electrolyte through the first half-cell to be different from a controller controlled flow rate of the negative terminal liquid electrolyte through the second half-cell.

The first and second return systems may include gravity return systems, such that the positive terminal liquid electrolyte is fed into a first collection tank after having exited the first half-cell without using a pump and then selectively returned from the first collection tank to the first storage tank, and the negative terminal liquid electrolyte is fed into a second collection tank after having exited the second half-cell without using a pump and then selectively returned from the second collection tank to the second storage tank.

One or more embodiments provide a flow battery control method of a flow battery system including a first battery stack including a first half-cell utilizing a liquid electrolyte, a first pressure feed system including at least a first storage tank and a first booster tank, and a return system to return the liquid electrolyte from the first half-cell to the first pressure feed system, the method including controlling a transportation of the liquid electrolyte in the first storage tank to the first booster tank, controlling a first booster pressure of the liquid electrolyte in the first booster tank to generate a sufficient first booster pressure in the first booster tank to force the liquid electrolyte to be fed from the first pressure feed system through the first half-cell when charging or discharging battery cells of the first battery stack, and controlling a feeding of the liquid electrolyte from the first pressure feed system to the first battery stack, to control a flow rate of the liquid electrolyte through the first battery stack when charging or discharging through battery cells of the first battery stack.

The method may further include controlling the return system of the flow battery system to transport the liquid electrolyte, after having exited the first battery stack, to one or more collection tanks using gravity feed without a pump, and controlling the return system of the flow battery system to transport the liquid electrolyte in the collection tank to the first storage tank.

The method may further include controlling the first pressure feed system to feed the liquid electrolyte from the first booster tank to the first battery stack without using a pump.

The controlling of the variable feeding of the liquid electrolyte may be performed by controlling a variable opening of a variable valve, in a fluid transport path of the liquid electrolyte from the first pressure feed system to the first battery stack, and the variable feeding controls a flow rate of the liquid electrolyte in the first battery stack based on a determination of the first booster pressure.

The controlling of the first booster pressure in the first booster tank may be performed by controlling a booster tank pump, arranged in a fluid transport path between the first storage tank and the first booster tank, to selectively transport the fluid electrolyte from the first storage tank to the first booster tank with a pressure controlled to generate the sufficient first booster pressure in the first booster tank.

The flow battery system may further include a first booster tank pressure sensor to detect the first booster pressure, a temperature sensor in at least one of the first booster tank and the first storage tank, and a state of charge (SOC) detector to determine a state of charge of the electrolyte stored in at least one of the first booster tank and the first storage tank, wherein the method may further include determining the sufficient first booster pressure based upon determined results of the first booster tank pressure sensor, the temperature sensor, and the state of charge detector to generate a desired electrolyte flow rate through the first battery stack.

The flow battery system may further include a second battery stack, including a second half-cell, at a height different from a height of the first battery stack, and a second booster tank, and the method may further include controlling a transportation of the liquid electrolyte in the first storage tank to the second booster tank, controlling a second booster pressure of the liquid electrolyte in the second booster tank to generate a sufficient second booster pressure in the second booster tank to force the liquid electrolyte to be fed from the first pressure feed system through the second half-cell when charging or discharging battery cells of the second battery stack, controlling the first booster pressure in the first booster tank to be the sufficient first booster pressure based upon a controlled pressure produced by the controlling of the transportation of the liquid electrolyte in the first storage tank to the first booster tank, and controlling the second booster pressure in the second booster tank to be the sufficient second booster pressure based upon a controlled pressure produced by the controlling of the transportation of the liquid electrolyte in the first storage tank to the second booster tank.

The flow battery system may further include a second pressure feed system, including a second storage tank and second booster tank, liquid electrolyte stored by the first storage tank is charged liquid electrolyte and liquid electrolyte stored by the second storage tank is depleted liquid electrolyte, and the method may further include controlling a transportation of the liquid electrolyte in the second storage tank to the second booster tank, controlling a second booster pressure of the liquid electrolyte in the second booster tank to generate a sufficient second pressure in the second booster tank to force the liquid electrolyte to be fed from the second pressure feed system through the first half-cell when charging battery cells of the first battery stack, controlling the first booster pressure in the first booster tank to be the sufficient first booster pressure based upon a controlled pressure produced by the controlling of the transportation of the liquid electrolyte in the first storage tank to the first booster tank, and controlling the second booster pressure in the second booster tank to be the sufficient second booster pressure based upon a controlled pressure produced by the controlling of the transportation of the liquid electrolyte in the second storage tank to the second booster tank.

Additional aspects and/or advantages will be set forth in part in the description which follows and, in part, will be apparent from the description, or may be learned by practice of the invention.

### BRIEF DESCRIPTION OF THE DRAWINGS

These and/or other aspects and advantages will become apparent and more readily appreciated from the following description of embodiments, taken in conjunction with the accompanying drawings of which:

FIG. 1 illustrates a pump-feed flow battery system with a battery stack elevated above storage tanks for gravity return;

FIG. 2 illustrates a gravity feed flow battery with storage tanks elevated above a battery stack for gravity feed;

FIG. 3 illustrates a pressure feed flow battery system, according to one or more embodiments;

FIG. 4 illustrates a pressure feed flow battery system with booster and collection tanks, according to one or more embodiments;

FIG. 5 illustrates one half-cell side of a four-tank arrangement pressure feed flow battery system with booster and collection tanks, according to one or more embodiments;

FIG. 6 illustrates one half-cell side of a divided two-tank arrangement pressure feed flow battery system with booster and collection tanks, according to one or more embodiments;

FIG. 7 illustrates one half-cell side of a two-tank arrangement pressure feed flow battery system, with booster and collection tanks, and multiple battery stacks, according to one or more embodiments; and

FIG. 8 illustrates a pressure feed flow battery system, with booster and collection tanks, and sensor and controllers, according to one or more embodiments.

### DETAILED DESCRIPTION

Reference will now be made in detail to one or more embodiments, illustrated in the accompanying drawings, wherein like reference numerals refer to like elements throughout. In this regard, embodiments of the present invention may be embodied in many different forms and should not be construed as being limited to embodiments set forth herein. Accordingly, embodiments are merely described below, by referring to the figures, to explain aspects of the present invention.

One or more embodiments relates to a method of using pressure to control the distribution of electrolytes through a battery stack portion of a redox flow battery. In one or more embodiments, such a pressure feed approach can be used to distribute electrolytes through the battery stack(s) without the need to place pumps between the electrolyte storage tanks and the battery stack(s). In one or more embodiments, several methods of using pressurized tanks to provide sufficient head pressure to push electrolyte through the battery stack(s) may be shown, which may eliminate the need to elevate the electrolyte storage tanks themselves. Through the use of such pressurized tanks, as only an example, a near laminar flow of electrolyte may be introduced to the battery stack(s) thus reducing stress on the battery stack membranes. In addition, as such a pressure feed approach can be accomplished without elevating storage tanks containing electrolyte acid solutions, cost and safety concerns can be alleviated over conventional gravity feed systems that require elevation of the electrolyte acid solutions. Still further, in addition to such laminar flow of electrolyte into the battery stack(s), conventional turbulent effects from a return pump connected to the outlet of the battery stack(s) can be avoided by a novel return system that can use gravity to return electrolyte from the battery stack(s) to an independent collection tank, with pumping of the electrolyte being performed from the collection tank back into the storage tank. Thus, with the elimination of a need of a pump directly before or after the battery stack(s), the battery stack(s) can be effectively isolated from turbulence generating elements of the flow battery system. One or more embodiments also offer the ability to “black start” the flow battery without need for external power.

In one or more embodiments, pressure differences across a flow battery membrane may be reduced, turbulence induced membrane fluttering may be reduced, and feedback induced membrane oscillations in flow batteries may be reduced, which may prolong battery life and operation. In redox flow batteries the energy is stored in two liquid electrolytes; a positive electrolyte or catholyte, and a negative electrolyte or anolyte. The two electrolytes may be separated from one another by an ion exchange membrane. In one or more embodiments, the electrodes are generally inert and only serve to collect or distribute the electric charge from the battery cell(s). The amount of power that can be stored or retrieved from such a flow battery is determined by the amount of membrane surface area. In one or more embodiments, due to novel improvements to the distribution of positive and negative electrolyte through the battery stack(s), a more efficient laminar-like flow of electrolyte into flow battery stacks can be achieved. One or more embodiments may also provide a more precise control over the flow rates and allows the head pressure to be quickly varied over a wide range of values. Methods of one or more embodiments can also be implemented to control the flow battery charge and discharge rates under a wide range of State of Charge (SOC) conditions, thus increasing the over-all battery efficiency. Still further, one or more embodiments provide flow battery system with a simple approach for dynamically countering electrolyte water transfer problems.

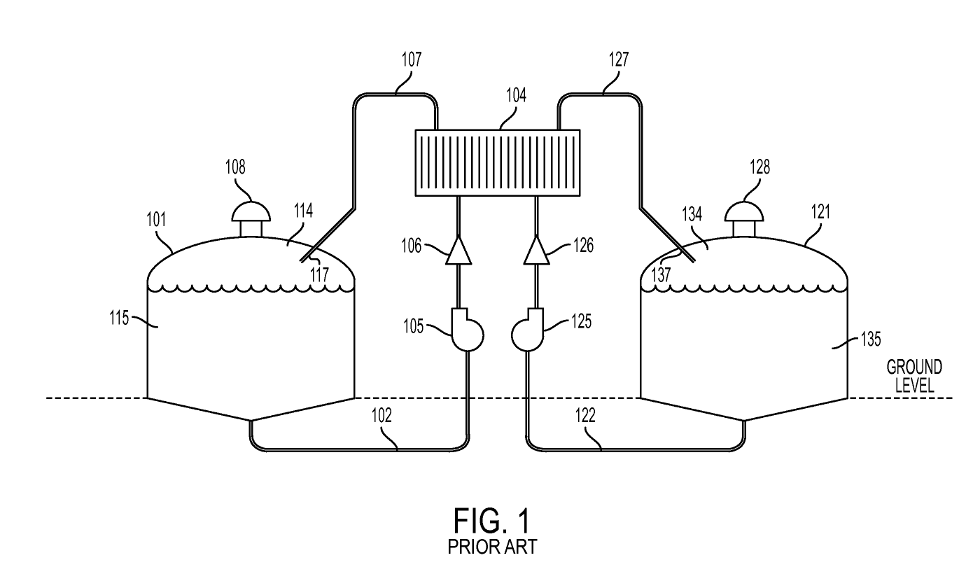

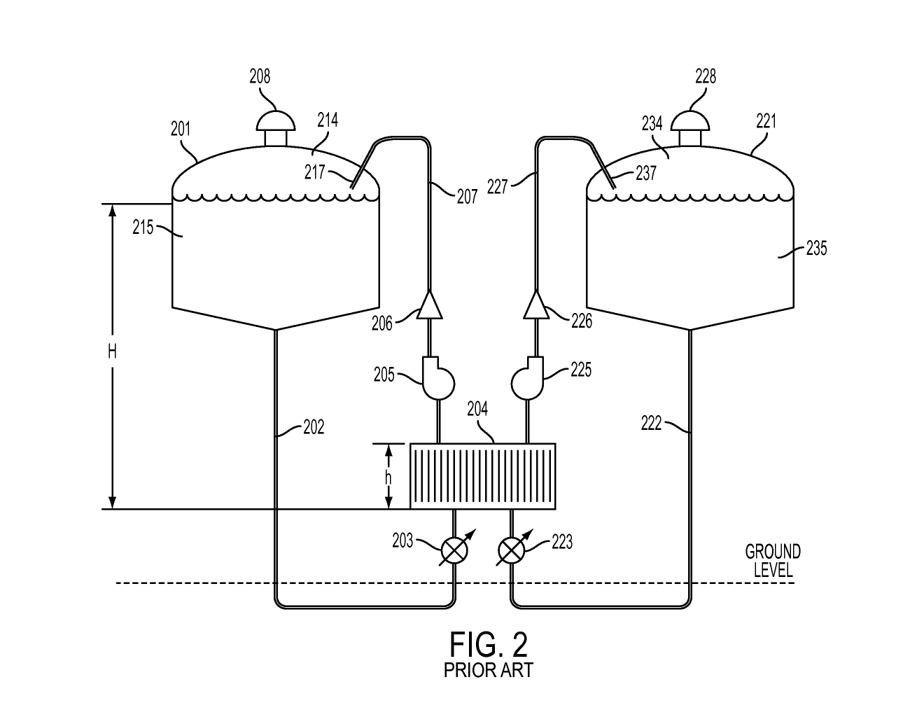

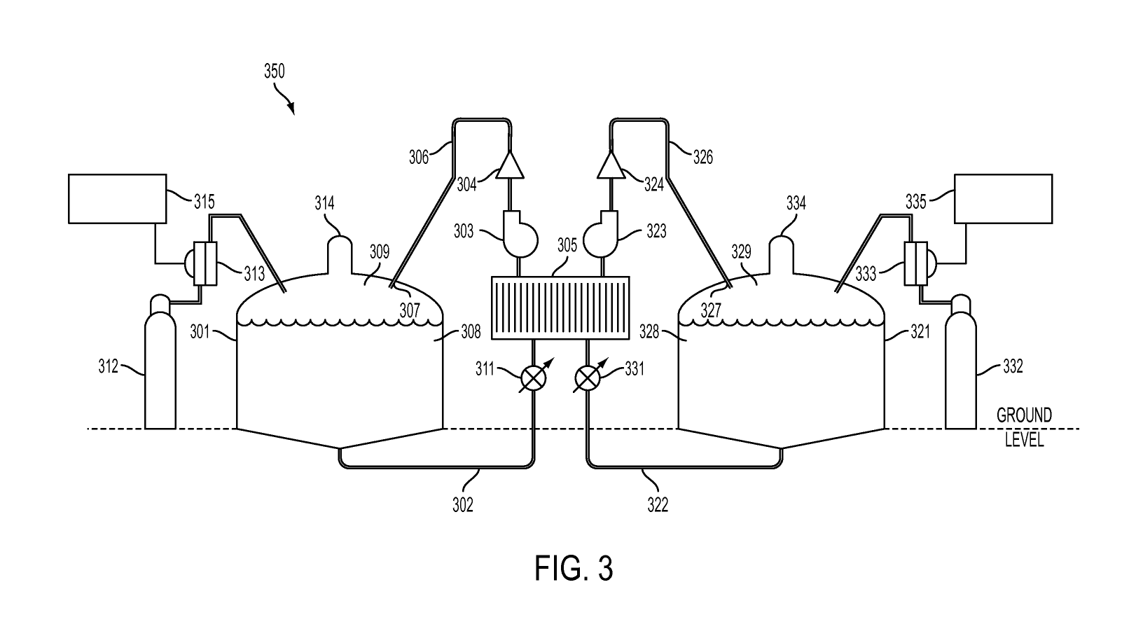

FIG. 3 illustrates a pressure feed flow battery system 350, according to one or more embodiments. In one or more embodiments, the storage tanks 301 and 321 may be reinforced to allow internal pressures to be higher than merely atmosphere pressure commonly used in conventional gravity feed systems. As illustrated in FIG. 3, gases 309 and 329 above the respective electrolytes 308 and 328 are maintained at elevated pressures and, therefore, push down on the electrolytes 308 and 328, imparting an elevated pressure on the electrolytes 308 and 328. Here, the gasses 309 and 329 may be inert gasses, may be the same inert gasses, or may be gasses determined to be most desirable for the respective electrolytes 308 and 328. The electrolytes are thereby given sufficient head pressure to push the electrolyte through respective pipes 302 and 322, through variable valves 311 and 331, and into the illustrated example bottom left and right input ports of the battery stack(s) 305. The electrolyte then emerges from respective illustrated example top left and right output ports of the battery stack(s) 305 with a lower pressure. The pumps 303 and 323 and one-way valves 304 and 324 then respectively transport the electrolyte through pipes 306 and 326 back into storage tanks 301 and 321 where the respective electrolytes are sprayed or dripped into the storage tank by one or more respective nozzles 307 and 327. Though the left and right illustrated electrolyte flow systems are shown as being symmetric, embodiments are not limited to the same and even with similar configurations differing or the same pressures may be generated causing differing or the same flow rate of electrolytes through the battery stack(s) 305. The snorkel mechanism for the storage tanks, shown in the conventional flow battery systems of FIGS. 1 and 2, is not included in the embodiment shown in FIG. 3, since in this arrangement it may not be desired to equalize the pressure inside the storage tanks 301 and 321 with the external atmospheric pressure. In one or more embodiments, for example, bulbous gas cavities 314 and 334 may be installed at the top of the storage tanks to increase the gas volume in order to help buffer the effects of changing fluid levels in the storage tanks 301 and 321.

The elevated pressures inside of storage tanks 301 and 321 may be primarily maintained by the action of the pumps 303 and 323, which increase the pressure of the electrolytes during transport, through their associated one-way valves 304 and 324. The pumps 303 and 323 may roughly set the pressure inside the tanks to the desired pressure range. In one or more embodiments, the pressure within each of the storage tanks 301 and 321 may be brought to an exact desired pressure by feeding additional high pressure gas, such as nitrogen gas from very high pressure gas tanks 312 and 332, into the space above the electrolytes 308 and 328. Regulators 313 and 333 may selectively add pressurized gas, or bleed off excess gas pressure, from the spaces 309 and 329 above the electrolytes. Additionally, in one or more embodiments, the controllers 315 and 335 may control the setting of the desired pressures into pressure regulators 313 and 333, thereby allowing the storage tanks', or booster tanks' in the below discussed embodiments, pressures to be dynamically changed as required by changing circumstances. The controllers 315 and 335 may be programmable controllers to implement such a dynamic changing of the pressure in spaces 309 and 329.

In FIG. 3 the electrolyte storage tanks 301 and 321 may be situated at ground level. The bottoms of the storage tanks 301 and 321 are shown to have a funnel like shape that protrude somewhat into the ground, and some of the plumbing is also shown below ground level, noting that alternatives are available. The bottoms of the storage tanks 301 and 321 may be flat, curved, or have more complex shapes determined by other requirements. This is an advantageous arrangement of the tanks and plumbing, but it is understood that various environmental, safety, or economic considerations may preclude this arrangement, or weigh in favor of alternate arrangements, at a particular installation.

In the battery stack(s) 305, the two electrolytes may be separated from one another by an ion exchange membrane. Depending on embodiment, positive and negative electrodes of a battery cell may be inert and serve to collect or distribute the electric charge to, from, or between the battery cell(s). The membrane may divide a battery cell of a battery stack into two half-cells, for example, with each half-cell having at least one electrode, e.g., a respective positive or negative electrode depending on the half-cell. Here, each half-cell may be made up of a rectangular frame with a central rectangular cavity, with the membrane being stretched across one side of the frame and a conductive graphite plate, as only an example, serving as the electrode and extending across the other side of the frame, noting that alternative arrangements are equally available. Depending on embodiment, a rectangle of electrically conductive carbon felt may be of a form so as to fit inside and fill the entire cavity of each half-cell to assist in collecting or distributing electric charge from the electrolyte. In one or more embodiments, the membranes may be a cation exchange membrane that only allows the exchange of positively charged ions (cations) or an anion exchange membrane that only allows the exchange of negatively charged ion (anions). Alternatively, the membrane may be a neutral or reversible membrane that can allow ion flow in either direction. Differencing membrane types may be used, or only the same membrane type may be used.

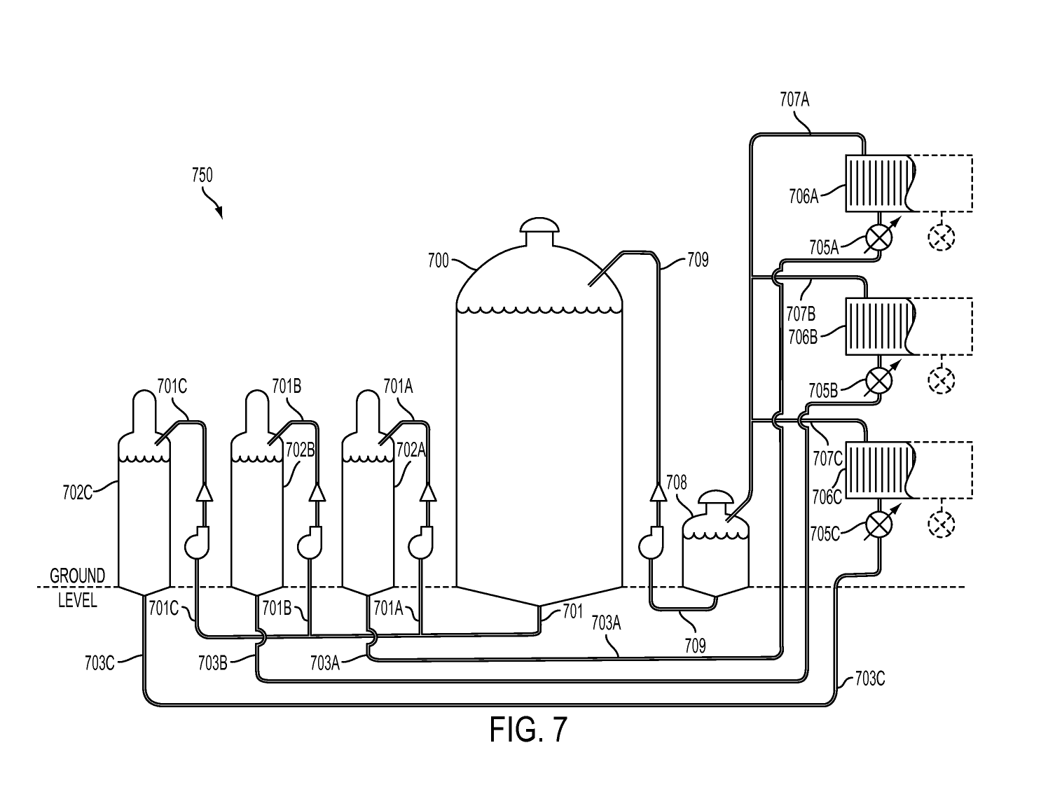

As shown in FIG. 3, positive electrolyte could be controlled to flow through an example positive half-cell, e.g., based upon control of variable valve 311, and negative electrolyte could be controlled to flow through an example negative half-cell, e.g., based upon control of variable valve 331, and charges could be drawn from or introduced to the respective electrolytes of the positive and negative half-cells. The battery stack(s) 305 may be made up of one or many half-cells that positive electrolyte is present or transported through along with one or many half-cells that negative electrolyte is present in or transported through. As discussed in more detail below, there may also be many such battery stack(s) 305, such as demonstrated in FIG. 7, as only an example, and each battery stack 305 may represent a collection of such multiple battery cells, and include internal flow elements or plumbing to transport a positive electrolyte between positive electrode half-cells and a negative electrolyte between negative electrode half-cells, or between an inlet and outlet of the battery stack(s) 305, as only examples, noting that alternative battery cell arrangements with alternative internal plumbing are available, such that embodiments should not be limited to only the descriptions herein. Similarly, as noted, FIG. 7 demonstrates one example of how battery stacks may be provided electrolyte, where the appropriate positive or negative electrolyte inlet of each battery stack 706a, 706b, and 706c is provided electrolyte separately through respective different feed lines or plumbing. However, herein, alternative arrangements for multiple battery stacks are also available, such as an in-line flow where electrolyte flows through more than one battery stack before being returned through the return system to the storage tank. Again, in the embodiments herein, alternative arrangements of the plumbing to respective battery stacks, or between battery stacks, are also available, and embodiments should not be limited to only the descriptions herein. There may be differing methods of transporting positive and negative electrolytes among the battery stack(s) and/or for transporting positive and negative electrolytes directly to respective battery stacks, or alternate groupings of battery stacks. Such alternative arrangements of internal plumbing of the battery stack(s), and alternative plumbing of the feed line(s) and for respective plural battery stacks, and selective mixing of the same, e.g., depending on installation, should be interpreted as being available for each of the described embodiment herein.

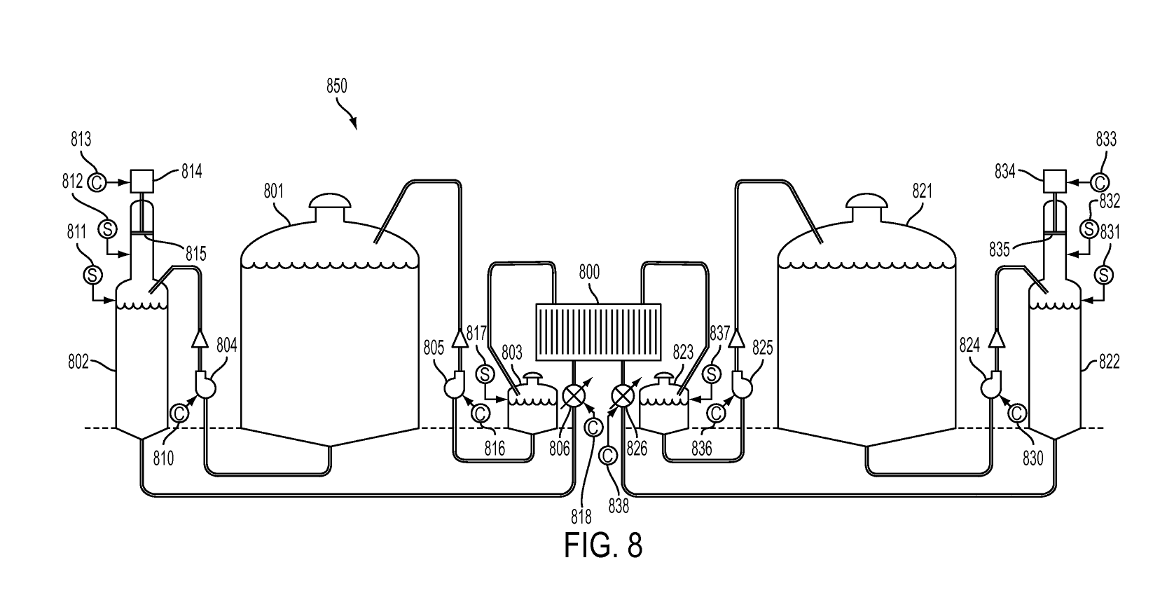

In addition, FIG. 3 further illustrates controllers 315 and 335, which may control regulators 313 and 335. In addition, or in alternative, one controller (or the illustrated two controllers 315 and 335) may be connected, or at least in communication with one or more of the return pumps 303 and 323, variable valves 311 and 331, other electrolyte transportation elements in the flow battery system 350, electrolyte height sensors in any of electrolyte storing tanks and/or battery stack(s) 305, or pressure sensors in any of the electrolyte storing tanks, battery stack(s) 305, or electrolyte transportation lines, as only examples. As only examples, FIG. 8 demonstrates some example placements of such height and pressure sensors and corresponding controllers. However, the illustrated electrolyte height sensors are not meant to represent the singular example placement of height sensors in each of the electrolyte storing tanks. Similarly, the positions or locations of pressures sensors are not meant to represent the singular example placement of the pressure sensors. The controllers 315 and 335, or a single controller 315 for example, that may be used as discussed above may include one or more processing devices or microcontroller, or the like hardware elements, that may implement any desired controlling of the elements of the flow battery system 350, or remaining flow battery system embodiments discussed herein, for transportation of electrolyte through the battery stack(s) 305, e.g., for charge or discharge through the battery cells of the battery stack(s) 305.

As only an example, in one or more embodiments, any of the controllers 315 and/or 335 may control a variance in the variable opening of the variable opening valves 311 and 331 and operation of return pumps 303 and 323 to respectively transport the positive and negative electrolytes through the battery stack(s) 305 for charging or discharging of stored charge, e.g., through positive and negative electrodes of the battery stack(s) 305, or control a ceasing of such positive and negative electrolyte transportation for maintenance of stored charge in the storage tanks 301 and 321, for example. In one or more embodiments, the controlling of the respective variable opening valves 311 and 331 may be to produce a desired flow rate through the battery stack(s) 305, or desired head pressure at the bottom or inlet of the battery stack(s) 305, based upon respective expected/controlled pressures within each storage tank 301 and 321 and any hydrostatic pressure caused by the height of the electrolyte in the respective storage tanks 301 and 321 and the height of the battery stack(s) 305, for example. Thus, the head pressure at the bottom or inlet of the battery stack(s) 305 may be based on the known physical properties and arrangement of the elements of the flow battery system 350 and the controlled pressure within spaces 309 and 329 above the electrolytes 308 and 328 in respective storage tanks 301 and 321. The respective head pressures at the bottom or inlet of the battery stack(s) 305 may also depend on a control of the respective return pumps 303 and 323, e.g., by controllers 315 and/or 335. As noted above, the return pumps 303 and 323 may generate, and may be selectively controlled to generate, a sufficient suction force that may affect the head pressure at the bottom or inlet of the battery stack(s) 305.

In one or more embodiments, the size and number of the battery stacks may be designed to meet maximum power requirements of the application and the quantity of electrolyte in the storage tanks can be specified to meet the required hours of operation. For example, in an embodiment of an all-vanadium redox flow battery, the flow battery could be fabricated using 100 10,000 watt battery stacks to provide the capability of providing a megawatt of electric power. The flow battery could be provided with storage tanks containing 12,500 gallons of 1.56 molar electrolyte, which would give the flow battery sufficient electrolyte to operate for one hour. The flow battery could be increased to provide one megawatt of power for eight hours by simply increasing the amount of electrolyte by eight times, while making no changes to the battery stacks. This design flexibility makes flow batteries ideally suited for storing power for large installations, like the entire electric output of a wind farm or solar array. In one or more embodiments, the flow battery would be designed to store electric power at the time it is generated by these intermittent sources of power and releasing it to consumers during the times of day when it is needed. In one or more embodiments, such large scale flow batteries also supply back-up power, power leveling, grid voltage and/or frequency regulation, spinning reserve, load shifting, and other applications.

Herein, the battery stacks may have different configurations, wherein the inlet of the battery stacks may be on a lateral, top, or bottom side, just as the outlet may also be on a lateral, top, or bottom side. The inlet and outlet of the battery stacks may be configured on a same side, adjacent sides, or opposite side, as only examples, noting that battery stacks can have many different physical arrangements with multiple sides. Differing configured battery stacks may also be included in the same flow battery system. Similarly, depending on embodiment and respective elements and configurations, each of the flow battery embodiments described herein include such a controller configured to control elements of the respective flow battery systems charge, discharge, and maintenance of charge, as only an example. In embodiments herein, though the transportation system and control of positive electrolyte through a first half cell and negative electrolyte through a second half cell, e.g., through separate inlets of a battery stack, has been demonstrated as being the same for both positive and negative electrolytes, embodiments are not limited thereto. One or more embodiments may have different feed and/or return approaches for the positive electrolytes compared to the negative electrolyte, which may result in the controller having to differently control the transportation of the positive and negative electrolytes through the respective feed and/or return systems. Similarly, in embodiments with multiple booster and/or collection tanks, there may be different feed and/or return approaches. Still further, in differing embodiments, it may be desired to have different flow rates of positive electrolyte through a positive side half-cell compared to negative electrolytes through the corresponding negative side half-cell, and this may be implemented through having a higher pressure in the space of the positive electrolyte storage tank or booster tank for the positive electrolyte feed system compared to the pressure in the space of the negative electrolyte storage tank or booster tank of the negative electrolyte feed system, or by controlling a differing pressures in respective booster tanks, as discussed in greater detail below. Accordingly, depending on desired implementation, aspects of different embodiments described herein may be selectively combined and respectively controlled by such a controller.

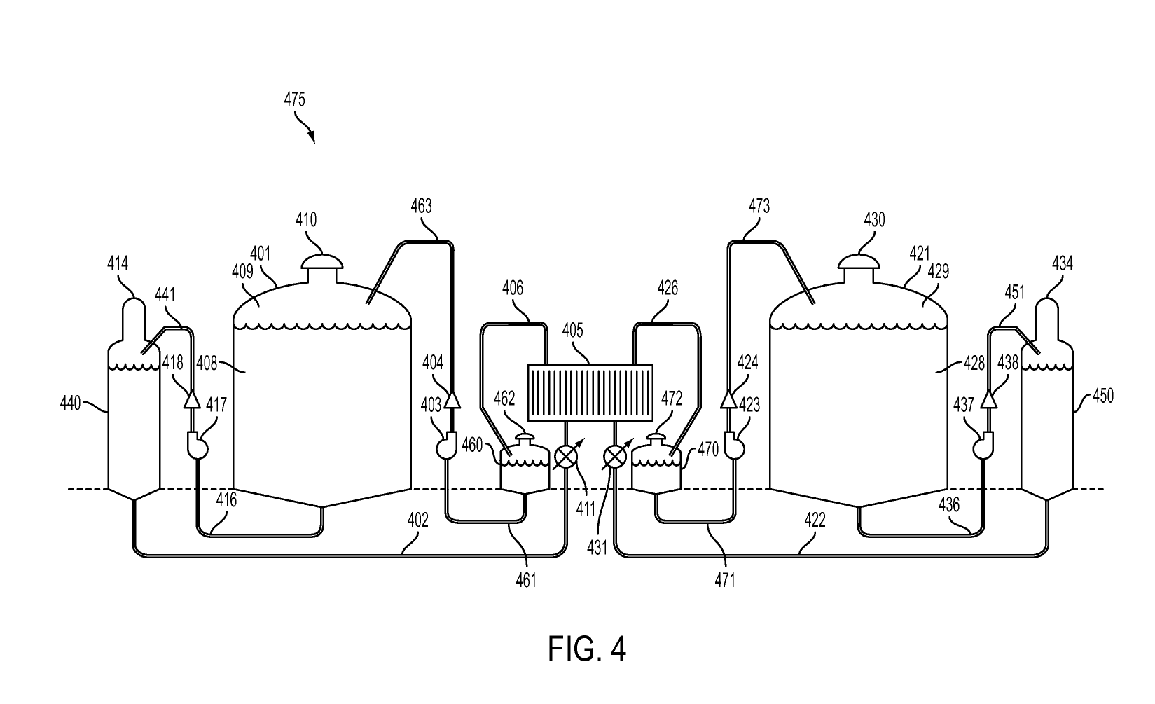

FIG. 4 illustrates a pressure feed flow battery system 475 with booster and collection tanks, according to one or more embodiments. In one or more embodiments, by using booster tanks 440 and 450 and collection tanks 460 and 470 the need to pressurize the storage tanks 401 and 421 may be eliminated, compared to the approach demonstrated in FIG. 3. In the arrangement of FIG. 4, electrolytes 408 and 428 may be respectively stored in storage tanks 401 and 421 at atmospheric pressure. In one or more embodiments, electrolyte 408 may be pumped out of the storage tank 401 and into a booster tank 440 that is maintained at relatively higher pressure than the storage tank 401. In one or more embodiments, the booster tank 440 is smaller than the storage tank 401, and the space 409 above electrolyte 408 in storage tank 401 may be maintained at atmospheric pressure, e.g., using snorkel 410. In more detail, electrolyte is caused to travel through pipe 416 by pump 417 and one-way valve 418, and through pipe 441 into the booster tank 440. The pump 417 can be used to both transport electrolyte into booster tank 440 and boost the pressure within the booster tank 440, so the booster tank 440 has a pressure greater than atmospheric pressure. In addition, in one or more embodiments, pressure within booster tank 440 may be maintained by a regulator and controller, such as shown in FIG. 3, which may more precisely regulate the gas pressure in the booster tank 440. When electrolyte flow is required by operation of the flow battery, variable valve 411 may be controlled to be opened to allow electrolyte to flow along pipe 402 from booster tank 440, through the variable valve 411, and into the example bottom or inlet of the battery stack(s) 405.

Electrolyte may normally emerge from the top or outlet of the battery stack(s) 405 at a low pressure, compared to the pressure of the electrolyte when entering the battery stack(s) 405. In one or more embodiments, instead of pumping the electrolyte directly from the battery stack(s) 405 back into the storage tank 401, the electrolyte may be first directed into a collection tank 460, where electrolyte may be allowed to accumulate. For example, when sufficient electrolyte is collected in the collection tank 460, e.g., as detected by a sensor, the controller may turn on pump 403 and open valve 404, thereby withdrawing the electrolyte from the collection tank 460 along pipe 461, moves it along pipes 461 and 463, and back into the storage tank 401.

In one or more embodiments, the illustrated right side of the flow battery system 475 of FIG. 4 may be identical to the illustrated left side of the flow battery system 475, though embodiments are not limited to the same. Thus, in one or more embodiments, electrolyte 428 may be pumped by pump 438 from the storage tank 421 through pipes 436 and 451 and valve 438 into the booster tank 450. From there, when the flow battery is operated, electrolyte flows from booster tank 450 through pipe 422, through variable valve 431, and into the bottom or inlet of the battery stack(s) 405. Electrolyte leaving the battery stack(s) 405 may then flow, e.g., by a gravity flow, into collection tank 470 and is then selectively controlled to be pumped along lines 471 and 473 through valve 424 back into the storage tank 421.

In on or more embodiments of FIG. 4, the storage tanks 401 and 421, as well as the collection tanks 460 and 470, may be maintained at atmospheric pressure by using example snorkels 410, 430, 462, and 472. This reduces the cost of these relatively lower pressure electrolyte storage tanks, as pressure within spaces 409 and 429 of storage tanks 401 and 421 does not need to be maintained at a particular pressure. This arrangement also reduces the safety risk of having high-volume high-pressure acid filled tanks. In one or more embodiments, only the relatively smaller booster tanks may need to be constructed of reinforced materials to withstand the higher pressure fluids. This arrangement of booster and collection tanks may also serve to isolate the battery stack(s) 405 from pump disturbances, both on the input and output side, thus allowing for near laminar flow of electrolyte fluids to pass through the battery stack(s) 405, if desired.

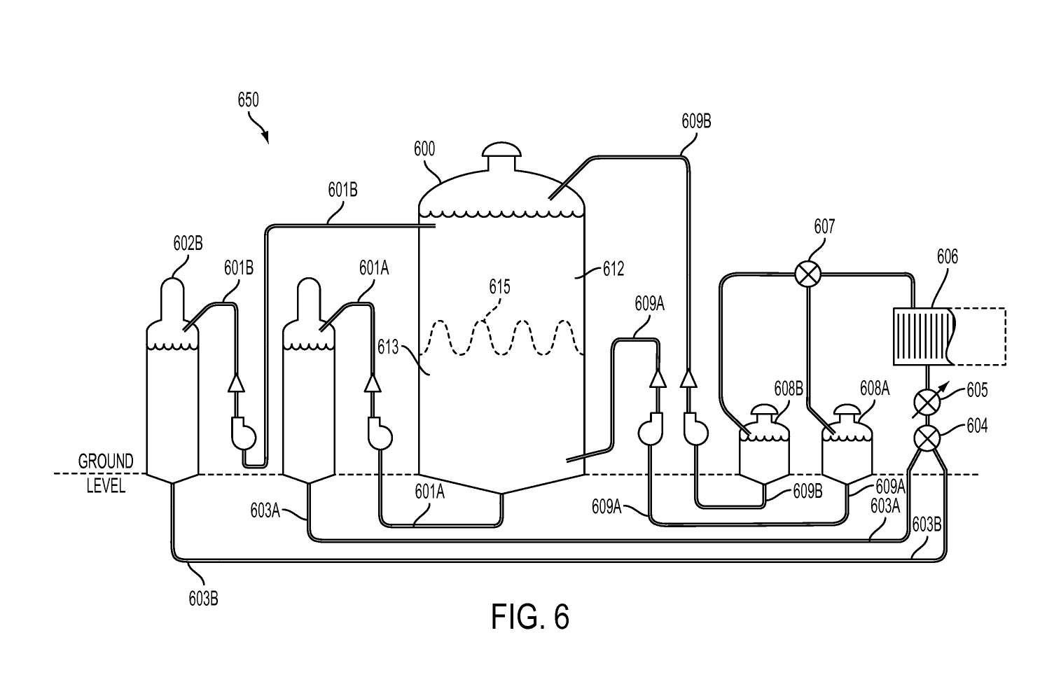

Redox flow batteries may have a two-tank or four-tank configuration. In a two-tank configuration, such as that described above with regard to FIG. 4, both depleted and charged positive electrolyte may be stored in a single storage tank; and likewise both the depleted and charged negative electrolyte may be stored in a second tank. In the two-tank configuration both the charged and uncharged electrolytes are generally constantly being mixed together. If the charged and uncharged electrolytes are mixed together then the resulting mix has a State-Of-Charge (SOC), which is simply the ratio of charged electrolyte to the total electrolyte in the tank. However, in some cases it may be of advantage to spray or drip the electrolyte emerging from the battery stack(s) into the top of the storage tank and withdraw electrolyte from the bottom of the storage tank with as little mixing of electrolyte within the tank as possible. In one or more embodiments, a physical barrier is placed between the charged and discharged electrolyte within a single tank to form a divided two-tank arrangement, such as described below with regard to FIG. 6.

In the four-tank configuration the charged and uncharged electrolytes may be stored in separate storage tanks. Thus there may be two positive electrolyte storage tanks; one for the charged positive electrolyte and one for the uncharged positive electrolyte. Likewise there may be charged and uncharged storage tanks for the negative electrolyte. Under this configuration, during the charging cycle, uncharged electrolyte may be drawn from the uncharged electrolyte storage tank, charged-up by the battery stack(s), and then sent to the storage tank that stores the charged electrolyte. The reverse procedure may take place during the discharge part of the flow battery cycle. The problem with this system is that it usually requires more than one pass through the battery stack(s) before the electrolyte gains a high SOC so there are intermediate charge states to deal with. The second problem is that a four-tank configuration needs twice as much tank volume as there is electrolyte volume. This may be a serious problem if there are space limitations. Also there is the added expense of the additional storage tanks. The advantage of the four-tank system is that the electrolytes require fewer passes through the battery stack(s) to reach the required SOC, thus reducing pumping cost.

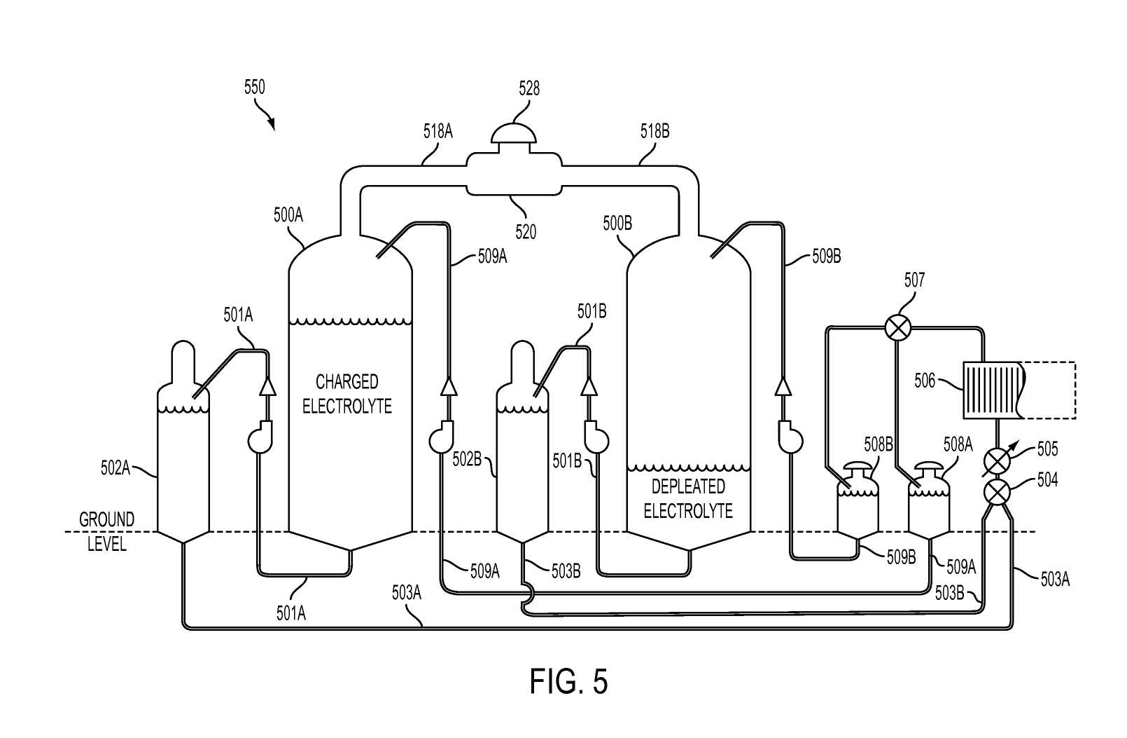

Accordingly, FIG. 5 illustrates one half-cell side of a four-tank arrangement pressure feed flow battery system 550 with booster and collection tanks, according to one or more embodiments. In order to reduce the complexity of explanation, only the one half of the four-tank system is illustrated in FIG. 5. In this arrangement charged and depleted electrolytes are stored in separate storage tanks 500A and 500B, though the system may not maintain sufficient electrolyte to fill both storage tanks 500A and 500B. In an embodiment, the total electrolyte stored in storage tanks 500A and 500B may be only enough electrolyte sufficient to fill one of the storage tanks 500A and 500B. In one or more embodiments, and as illustrated, the storage tanks 500A and 500B respectively containing charged and discharged electrolyte each has its own set of booster and collection tanks with appropriate valves and pumps to transfer electrolyte. Using storage tank 500A as an example, during a discharge cycle, electrolyte may be transferred from the bottom of the storage tank 500A to the top of its booster tank 502A along pipe and pump line 501A. The high pressure charged electrolyte in booster tank 502A may then be allowed to flow along pipe 503A to three-way valve 504. The valve 504 may be controlled to be switched to allow charged electrolyte to continue to variable valve 505, which in turn may be controlled to allow the flow of electrolyte to continue into the battery stack(s) 506. The charged electrolyte gives up its charge in the battery stack(s) 506 and becomes discharged electrolyte based upon charge that is removed from the flow battery system 550, such as an exterior load or internal load of the flow battery system 550, e.g., the controller and powered systems of the flow battery system 500. This discharged electrolyte emerging from the top or outlet of the battery stack(s) 506 is then directed by three-way valve 507 to collection tank 508B, where it is accumulated. When a sensor determines that sufficient discharged, or depleted, electrolyte has been collected in collection tank 508B, the collected electrolyte is pumped from collection tank 508B along pipe and pump line 509B into the depleted electrolyte storage tank 500B.

In FIG. 5, during a charging mode, depleted electrolyte may be pumped out under pressure from storage tank 500B and into booster tank 502B by pipe and pump line 501B. Under pressure the depleted electrolyte may then be controlled to flow along pipe 503B, through the controlled 3-way valve 504, through controlled variable valve 505, and into the bottom or inlet port of the battery stack(s) 506. Inside the battery stack(s) 506 the depleted electrolyte may then be re-charged based upon charge input into the flow battery system 550, such as an exterior power grid or power source. The now charged electrolyte emerges from the top or outlet of the battery stack(s) 506 and is caused to be transported through valve 507 into the charged electrolyte collector tank 508A, where it accumulates. When a sensor detects that sufficient charged electrolyte has accumulated in the collector tank 508A, pipe and pump line 509A is controlled to transfer the contents of the collection tank 508A into the charged electrolyte storage tank 500A.

In FIG. 5 it can be noted that the electrolyte volumes may continuously change during battery operation which in turn cause the volume of inert gas above the electrolyte to change volume in reverse manor. It is generally desirable in flow batteries to keep the inert gas from mixing with outside air while at the same time maintaining the inert gas at atmospheric pressure. If the inert gas is mixed with outside air then any oxidizing characteristics of the outside air may interact with the stored electrolyte. These goals of keeping the inert gas from mixing with outside air and maintaining the inert gas at atmospheric pressure may be difficult to achieve in the storage tanks 500A and 500B when the gas volumes are constantly changing. Accordingly, in one or more embodiments, the illustrated pipe lines 518A and 518B connect the top areas of the storage tanks 500A and 500B. This feature takes advantage of the observation that the total gas volume between the two storage tanks may remain constant throughout battery operation, and thereby may help maintain both storage tanks 500A and 500B at atmospheric pressure and limit the mixing of respective inter gases with the outside air. In one or more embodiments, a bulbous section 520 of the connecting pipes 518A and 518B may be added to allow for the mounting of a snorkel 528. Alternatively, in one or more embodiments an equalizing of these gas volumes could be achieved by allowing the two storage tanks to each have their own snorkel feature and then connect top areas of storage tanks 500A and 500B with a simple pipe. In addition, as noted above, such connected gas volumes at the top areas of storage tanks 500A and 500B could also be connected to a supply of inert gas 312, a regulator 313, and a controller 315, such as featured in FIG. 3, to further maintain the inert gas at the correct pressure and volume.

The advantage of the four-tank gravity feed system is that it allows fully charged electrolyte to flow through the battery stack(s) during discharge and fully discharged electrolyte to feed the battery stack(s) during the charge cycle thus achieving maximum efficiency at all times. The disadvantages are that twice as many pumps, tanks, and plumbing may be required for the four tank flow battery system, thus potentially doubling the hardware cost. In a four-tank system, at any given moment, half of the storage tanks are empty. For given electrolyte capacity, a four-tank system will occupy roughly twice the physical volume as a two-tank system, making it less practical for some applications.

FIG. 6 illustrates one half-cell side of a divided two-tank arrangement pressure feed flow battery system 650 with booster and collection tanks, according to one or more embodiments. In order to reduce the complexity of explanation, only the one half of the divided two-tank system is illustrated in FIG. 6. In this arrangement the depleted electrolyte is maintained in one portion of the storage tank 600 and the charged electrolyte is maintained in the other portion of the storage tank 600, and a separator 615 separates the two sections of the storage tank 600. In one or more embodiments, as only an example, the separator 615 may be a piston-like structure that moves up and down, wherein the inside walls of the storage tank 600 serve as cylinder walls, so as to dynamically separate the storage tank 600 into different regions. Other hardware, such as rubber bladders, that completely or sufficiently separate the charged and discharged electrolytes into different regions within the storage tank 600 may also be used to dynamically separate the charged and discharged electrolytes. Likewise, other approaches, such as using a fibrous material to slow down the turbulent mixing between the charged and discharged electrolytes may also be used in regions of the storage tank 600.

In FIG. 6, during a discharging cycle of the flow battery, charged electrolyte from the bottom of the storage tank 600 is transferred into the booster tank 602A under pressure by the pump and pipe line 601A. When the flow battery is in discharge mode the charged electrolyte flows from the booster tank 602A along pipe 603A, and is then directed by three-way valve 604 to variable valve 605, and then into the bottom or inlet port of the battery stack(s) 606. The electrolyte emerges from the top or outlet port of the battery stack(s) 606 at a lower pressure and is directed by 3-way valve 607 into the collection tank 608B, which is reserved for the collection of depleted electrolyte. The pump and pipe line 609B then periodically transfers the contents of collection tank 608B to the top of the storage tank 600, such as discussed above in previous embodiments.

Continuing with FIG. 6, during a charging cycle of the flow battery, depleted electrolyte from storage tank 600, e.g., from the top of storage tank 600, is pumped under additional pressure along pump and pipe line 601B and into booster tank 602B. From there, under its own elevated pressure, the discharged electrolyte may be controlled to travel along pipe 603B, through three-way valve 604, through variable valve 605, and into the bottom or inlet of the battery stack(s) 606 where the input depleted electrolyte is transformed back into its charged state. Lower pressure charged electrolyte emerging from the top of the battery stack(s) 606 is then directed by 3-way valve 607 into collection tank 608A. Accumulated charged electrolyte stored in collection tank 608A is then periodically transferred to the bottom of the storage tank 600 by pump and pipe line 609A, such as discussed above in previous embodiments, thus completing the charging cycle in a divided two-tank arrangement.

The divided two-tank arrangement of FIG. 6 reduces the amount of hardware by one storage tank, as compared to the arrangement shown in FIG. 5, thus saving some tank cost and floor space. However, the addition of a divider mechanism 615 will add to the cost of manufacturing the storage tank 600. The innovative use of collection and booster tanks again allows for a near laminar flow of electrolyte through the battery stack(s), if desired. The divided two-tank arrangement may not work for flow batteries requiring more than one pass of the electrolyte through the battery stack(s) to fully charge or discharge the flow battery.

Briefly, in FIGS. 3-8 the battery stack(s) are schematically shown as a simple box with parallel lines symbolizing the battery cells. In practice a commercial flow battery would contain a large number of battery stacks, with each stack occupying as much as a cubic meter in volume. The battery stacks may be mounted on racks positioned at ground level or elevated as pictured in the diagrams. The battery stacks may be usually electrically wired together in series within each stack and in parallel between each stack, though alternate connection configurations are also available. Pathways, called manifolds, are provided to distribute the flow of positive and negative electrolyte within each battery stack. Tubes, pipes, valves, pumps, and other plumbing elements external to the individual battery stacks are used to collect and distribute electrolyte between the battery stacks and the storage tanks as appropriate. In large installations there may be hundreds of individual battery stacks, mounted on dozens of racks, with each rack having several shelves of battery stacks arranged at different heights above the floor. All battery stacks may need, if desired, to have the same head pressure at their electrolyte input ports in order to have the same flow rates flowing through each battery stack. In one or more embodiments, if the electrolyte is being stored in storage tanks at ground level, then the booster tanks may have to boost their pressures by differing amounts as respective electrolytes enters battery stacks at different levels above floor level. Depending on embodiment the flow rates within each battery stack may be controlled to be the same or selectively different, e.g., such as an embodiment where different battery stack arrangements or hardware are implemented in the same flow battery system.

As only an example, FIG. 7 illustrates one half-cell side of a two-tank arrangement pressure feed flow battery system 750, with booster and collection tanks, and multiple battery stacks, according to one or more embodiments. Here, in one or more embodiment, the example multiple battery stacks may be different heights, noting that plural battery stacks may also be respectively arranged at the same heights. In order to reduce the complexity of explanation, only the one half of the multiple battery stack system is illustrated in FIG. 7. In this arrangement of a large redox flow battery (RFB), with battery stacks at several different heights above ground level, the booster tanks sitting at ground level may be controlled to provide different fluid pressures so that each stack receives the same, or determined appropriate, input pressure at its unique elevation. The storage tank 700 feeds electrolyte through pipe 701, then simultaneously through pump and pipe lines 701A, 701B, and 701C to the three booster tanks 702A, 702B, and 702C. Each of the respective pumps may feed electrolyte at a different pressure to its corresponding booster tank, e.g., with booster tank 702A being pumped up to a highest pressure to overcome the greater height of its corresponding battery stack 706A compared to the illustrated heights of battery stacks 706B and 706C, as only an example. The pressure in each booster tank may be read by sensors and sent to the controller which regulates the pump activity to continually maintain each booster tank at the desired pressure. Each booster tank 702A, 702B, and 702C may also have a high pressure inert gas tank and regulator, as shown in FIG. 3, to assist in maintaining the desired booster tank pressure. The controller may control both the pump and pipe lines 701A, 701B, and 701C and such regulators so as to generate sufficient pressure so the electrolyte can be forced through the corresponding battery stacks 706A, 706B, and 706C. If regulating mechanisms 815 and 835, such as described with regard to FIG. 8 are implemented, the controller may similarly include control of the regulating these regulating mechanisms along with any regulator of such high pressure inert gas and pressures provided by pump and pipe lines 701A, 701B, and 701C. The sufficient pressures may be predetermined, and the controller may increase and/or decrease pressures provided by any of the regulating mechanisms, any regulator of such input high pressure inert gas, and pressures provided by pump and pipe lines 701A, 701B, and 701C based upon sensed pressures and/or determined electrolyte levels within booster tanks 702A, 702B, and 702C. If additional control is implemented, e.g., for osmotic cancellation, then the controller will implement that pressure control of the booster tanks 702A, 702B, and 702C. The electrolytes in booster tanks 702A, 702B, and 702C may, thus, be respectively self-propelled by their relatively higher pressures through pipe lines 703A, 703B, and 703C and into respective elevated stacks 706A, 706B, and 706C under the control of variable valves 705A, 705B, and 705C, and this self-propelling may be with sufficient pressure so electrolyte head pressure at the inlet of the battery stacks 706A, 706B, and 706C are respectively sufficient to force the electrolyte through each respective battery stack 706A, 706B, and 706C. The electrolyte emerging from the top or outlet ports of each of the elevated battery stacks 706A, 706B, and 706C may then be directed into branched pipe 707 and allowed to flow by gravity into a single collection tank 708, for example. The electrolyte may then be periodically pumped out of the collection tank 708 and returned to the storage tank 700 through the pump and pipe line 709, such as discussed above in previous embodiments. The top areas of both the collection tank 708 and the storage tank 700 may be maintained at atmospheric pressure.

In order to simplify FIG. 7 the right side of the multiple level flow battery is not illustrated. Generally the arrangement on the right side of the flow battery system 750 may be identical to the illustrated left side of the flow battery system 450. However, it is not a requirement that the two sides of the of the flow battery be identical; other design considerations may require an asymmetric arrangement of components between the negative and positive sides of the flow battery and even a difference in pressures between the negative and positive sides of the flow battery. For example in a vanadium redox flow battery having a cation membrane it may be desirable to maintain a higher electrolyte pressure on the negative side of the flow battery to counter water transfer caused by the action of osmosis. Compensation of this osmotic action will be discussed in greater detail further below.

Depending on embodiment, many variations of this multiple level electrolyte distribution system of FIG. 7, using such booster and collection tanks, are possible. The booster tanks 702A, 702B, and 702C could also be respectively elevated, e.g., to a height similar or the same as battery stack(s) 706A, 706B, and 706C. In this case all the booster tanks may be maintained at a same pressure and one or more of the lines, pumps, and/or valves in pump and pipe lines 701A, 701B, and 701C could be eliminated. In an embodiment, one tall booster tank, e.g., that reaches from a bottom of the lowest battery stack to top of the highest battery stack, may be used by connecting respective output pipes emerging from the booster tank at different heights, corresponding to the heights of the various battery stacks, to the respective battery stacks. In such an embodiment, only a single pump may be needed to fill and pressurize the tall booster tank. In one or more embodiments, multiple collection tanks may be used, with one collection tank for each level of battery stacks. Though three levels of battery stacks are shown in FIG. 7, embodiments include arrangements with any number of levels of battery stacks, whereby the innovative booster and collection tanks of this invention could be duplicated, as desired, and arranged in accordance with the teachings herein.

FIG. 8 illustrates a pressure feed flow battery system 850, with booster and collection tanks, and sensor and controllers, according to one or more embodiments. As only examples, approximate positions of sensors are indicated by small circles containing the letter “s” and approximate positions of a controller of a component, such as a valve or pump, is indicated by a small circle containing the letter “c”. The small circles have small arrows attached that point to their attachment positions. Here, though several sensor and controller positions are demonstrated, alternative placement, number, and configuration are equally available, depending on embodiment. In one or more embodiments, the flow battery system 850 of FIG. 8 includes temperature sensors and/or state of charge (SOC) detectors that may also be used by the controller, for example, to adjust or set the generated pressure in booster tanks 802 and 822 sufficient to generate a desired electrolyte flow rate through the battery stack(s) 800.

In the example of FIG. 8, the booster tanks 802 and 822 may supply electrolyte to the battery stack(s) 800 under constant pressure, for example. This control of the flow of electrolyte to the battery stack(s) 800 may be complicated by a controlling of pumps 804 and 824, by controllers 810 and 830, to intermittently add electrolyte to the booster tanks 802 and 822 and by a controlling of variable valves 806 and 826, by controllers 818 and 838, to intermittently enable electrolyte to exit from the respective booster tanks 802 and 822. These varying circumstances may cause the electrolyte level in the booster tanks 802 and 822 to vary, though it may also be desirable for the pressure of an inert gas above the electrolyte in each of the booster tanks 802 and 822 to remain constant, e.g., to a first approximation, to enable the flow of electrolyte into the battery stack(s) 800 to remain constant. In one or more embodiments, this may accomplished by using example regulator mechanisms 814 and 834. Sensors 811 and 831 report the level of electrolyte to the system controller and sensors 812 and 832 report the pressure of the inert gas above the electrolyte to the system controller. Using this sensor information and suitable algorithms the system controller may set controllers 813 and 833 to command the regulator mechanisms 814 and 834 to adjust or maintain the gas pressure above the electrolyte as required.

Under control of the system controller, e.g., connected to controllers 818 and 838, the variable valves 806 and 826 control the amount of electrolyte entering the battery stack(s) 800. The electrolyte passes through the battery stack(s) 800 and into the collection tanks 803 and 823. The height of the electrolyte in the collection tanks 803 and 823 may be detected by sensors 817 and 837 and reported to the system controller. When the collections tanks are full, or reach a predetermined height, the system controller may activate pumps 805 and 825, e.g., by controlling controllers 816 and 824, to return the collected electrolyte in collection tanks 803 and 823 to their respective storage tanks 801 and 821.

In FIG. 8, the inert gas in the booster tanks 802 and 822 is shown to be regulated by an example piston and cylinder arrangement whereby the regulator mechanisms 814 and 834 may control the heights of the pistons 815 and 835, which in turn controls the volume of the inert gas above the electrolyte, noting that alternative embodiments are equally available to control the respective inert gas pressure. In one or more embodiments, a flexible rubber-like inflatable bladder may be used to keep a constant pressure difference between the inside inert gas and the outside atmosphere. Alternatively, similar to above, a source of external high pressure gas and a regulator, as illustrated in FIG. 3, could be used to maintain the desired pressure in the booster tanks 802 and 822. Depending on embodiment, a combination of the above mechanisms, or other mechanisms, may be used as required to control the booster gas pressure.

The use of booster and collection tanks in one or more embodiments described herein, along with the included sensors and controllers, allows precise control over the flow rate of electrolyte into/through the battery stack(s). In one or more embodiments, in order to obtain maximum efficiency, the electrolyte flow rate may be adjusted in consideration of the electrolyte's state-of-charge (SOC), the temperature(s) of the electrolyte, and other conditions, during operation of the flow battery. One or more embodiments facilitate this precision of process control for maximizing battery efficiency over a wide range of flow rates. In one or more embodiments, including sensors and processing instructions with suitable controller processing hardware, the controller may periodically and intentionally run the flow battery at slightly a higher flow rate and then a slightly lower flow rate, compared to previously determined efficient flow rate(s), analyze the results on flow battery performance, and then adjust the electrolyte flow rate to be a more efficient rate based on the analysis results, e.g., so as to match the prevailing conditions. Conventional on/off feed pumps, such as illustrated in FIG. 1, or even variable speed pumps, are unlikely to be able to provide this level of precision control.

Accordingly, the flow battery system of one or more embodiments may perform precise control over the electrolyte flow rate into the battery stack. In one or more embodiments, during battery discharge, when the flow battery is highly charged, a low pumping speed may be used. As the electrolyte is discharged, the flow rate may be increased to provide more reactants to the battery stacks per unit time. In one or more embodiments, when the flow battery is being charged with the electrolyte in a nearly discharged state, a low pumping rate may only be desired. As the flow battery becomes charged the flow rate may be increased to supply increasingly more uncharged reactants to the battery stacks. Accordingly, in one or more embodiments, booster tank(s) may supply electrolyte to the battery stack(s) at a range of flow rates. For example, in one or more embodiments, a provided high electrolyte flow rate may be four times a provided low rate. Potentially more preferable, the provided higher electrolyte flow rate being eight times the provided lower electrolyte flow rate, or the like.

In one or more embodiments, the electrolyte flow rate may be measured by any number of flow rate sensors included anywhere along any pipe line(s) between an outlet of the booster tank(s) and the inlet(s) to the battery stack(s). The electrolyte flow rate at the outlet of the booster tank may be based on the height of the electrolyte in the booster tank, providing a hydrostatic pressure, and the pressure of the gas above the electrolyte in the booster tank. The electrolyte fluid pressure at the outlet of the booster tank, and thus the electrolyte's resulting flow rate, can be increased by using such an aforementioned pump to pump more electrolyte, e.g., from the storage tank, into the booster tank, and/or by using a gas regulator to maintain or adjust the gas pressure above the electrolyte in the booster tank.

In one or more embodiments, a simple method of providing a range of flow rates could be to initially begin flow battery operations with a lower height of electrolyte in the booster tank when a low flow rate is desired. At this point sufficient gas pressure may be maintained above the electrolyte to push electrolyte out of the bottom or outlet of the booster tank at the desired flow rate. As greater flow rates are needed or desired the height of the electrolyte in the booster tank may be increased. The greater height of electrolyte in the booster tank also increases the pressure at the bottom of the booster tank, e.g., the level of the outlet of the booster tank, and thus increases the flow rate out of the booster tank. However, the increased volume of electrolyte in the booster tank also decreases the volume available for the trapped gas at the top of the booster tank, as the booster tank is sealed in one or more of the aforementioned embodiments. Therefore, the gas pressure above the electrolyte in the booster tank increases, thus further increasing the fluid pressure on the electrolyte at the outlet of the booster tank. These two effects working together represent a combination of linear and exponential changes in pressure at the bottom, or outlet, of the booster tank as the level of the electrolyte increases or decreases.

In one or more embodiments, such simple approach may use two sensors per booster tank, as only an example. For example, one sensor (such as a float sensor or the like) may be desired to determine the height of the electrolyte inside the booster tank at any given moment, and a second sensor may be either a pressure sensor placed near the bottom (or outlet) of the booster tank or a flow meter sensor included in any of the above embodiments anywhere along the pipe line between the booster tank and the battery stack(s). After determining the desired flow rate at a particular moment in the flow battery operation, and determining the current flow rate from the flow sensor or pressure sensor, the controller of the flow battery system could activate the pump to pump more electrolyte, e.g., from the storage tank, into the booster tank to either maintain its current level or to increase its fluid level. If a lower flow rate is desired, a simplest procedure may be for the controller to allow the electrolyte to simply flow out of the booster tank and into the battery stack, without replacing electrolyte in the booster tank, until a desired lower fluid level is reached.

In one or more embodiments, a slightly more complicated approach is implemented by including a reversible pump that is used to either add or subtract electrolyte from the booster tank to more quickly maintain the desired flow rate, e.g., the pump illustrated in one or more embodiments to transport electrolyte from the storage tank could be a reversible pump, in which case the example one-way valves in the fluid path from the pump to the booster tank may be a two-way valve. In some applications this added complexity may not be economical.

A great advantage of the above described simple approaches of controlling the booster tank pressure is that, with regard to the gas above the electrolyte in the booster tank, it may not be necessary to include a mechanism to change the initial volume of gas above the electrolyte during normal flow battery operation. This volume or amount of gas above the electrolyte in the booster tank may be adjusted from time to time as gas slowly leaks out of the system or as required by a major maintenance procedure, as only examples. This occasional maintenance servicing of the trapped gas above the electrolyte in the booster tank could be accomplished by simple manually operated valves and external sources of high pressure gas without the need for expensive automated valves and sources of pressurized gas. This approach further reduces the cost of the flow battery system because it does not require an expensive variable speed pump. As also alternatively noted above, during operation of the flow battery system, regulation of the volume or amount of gas above the electrolyte in the booster tank may alternatively or additionally be controlled to adjust the flow rate of electrolyte out of the booster tank and ultimately into the battery stack(s).

Generally in a flow battery, the reactants and the concentration of the reactants differ between the positive and negative electrolytes across the semi-permeable membrane of one or more cells of a particular battery stack. Depending on membrane material, this difference typically causes an osmotic pressure difference to develop across the membrane, which in turn causes water and acid to flow through the membrane from the side of low reactant concentration to the side of high reactant concentration. This “water transfer” causes a dilution of reactants on one side of the flow battery, and if left unchecked will lead to a loss in battery efficiency.

For example, in an embodiment of a vanadium redox flow battery (VRFB) both sides of the flow battery have the same type of reactants, i.e., V(5)/V(4) vanadium ions on the positive side and V(2)/V(3) vanadium ions on the negative side. In this type of flow battery, water is typically predominantly transferred from the negative to the positive electrolyte. This causes the positive electrolyte to gain volume and become diluted while the negative electrolyte diminishes in volume and becomes concentrated. A usual solution to such water transfer is to periodically transfer excess electrolyte from the positive tank to the negative tank, and to thereby equalize the volumes. However, this transfer approach only provides a short term solution. As this transfer approach is carried out a number of times the concentrations of vanadium ions on the two sides of the flow battery will continue to slowly become unbalanced. When the ion imbalance becomes sufficiently great the usual correction method is to “rebalance” the flow battery by mixing the positive and negative electrolytes together and restarting the flow battery. For a large VRFB containing thousands of gallons of electrolyte, this process becomes time consuming and inefficient.

In one or more embodiments, osmotic pressure can be reversed by increasing the pressure on the side of the flow battery, i.e., the positive or negative side, having the high concentration of osmotic reactants. When the applied pressure exactly equals the osmotic pressure then the two will cancel and no net flow of water and acid will flow across the membrane due to osmotic pressure. Accordingly, in one or more embodiments, in addition to supplying the motive pressure needed to propel the electrolyte through the battery stacks, pressurizing of the booster tanks can also supply selectively unequal pressure to the two sides of the flow battery to exactly cancel the osmotic pressure.

Furthermore, the osmotic pressure varies with the electrolyte state of charge (SOC), temperature, and other factors during normal battery operation. Calculations can be performed on sensor data, e.g., by the controller of the flow battery system, to compute the momentary osmotic pressure and use this information to continuously adjust booster tank differential pressure to continuously counter the osmotic pressure. In one or more VRFBs embodiments, the use of booster tanks to counter osmotic pressure and the resulting water transfer, may eliminate the need to perform periodic volume equalization between the positive and negative electrolyte tanks, and eliminate the need to periodically perform rebalancing of the electrolytes. For other types of redox flow battery embodiments, the use of booster tanks supplying a pressure differential may eliminate water transfer and limit cross-contamination between the positive and negative electrolytes.

In one or more embodiments, a large flow battery is useful as an emergency back-up power source in the event that the electric grid power fails because of a storm or other cause. In this situation it may be desirable to provide back-up power with the smallest possible delay. This circumstance is referred to as “Black Start” battery operation. Under such circumstances the backup battery may or must be able to immediately begin supplying supplementary electric power upon detection of the grid failure. But flow batteries are complex mechanisms that depend on pumps, sensors, controllers, and other electronic devices for their operation so a grid failure would prevent conventional flow batteries from operating. It could be desirable that a flow battery could draw on its own stored power to black start itself. But if the flow battery has been standing unused for a time previous to the grid failure, the electrolyte contained within the battery stack(s) would very likely be self-discharged over time.

Accordingly, one or more flow battery embodiments have a systemic advantage in black start operations. For example, using FIG. 4 as only an example, by simply opening the variable valves 411 and 431 at the bottom or inlet of the battery stack(s) 405, fresh electrolyte may be immediately introduced to the battery stack(s) 405 enabling the initiation of a self-start sequence. A small battery pack may be included in the flow battery system 475 to provide the power needed to activate a controller(s) of the variable valves 411 and 431 and maintain grid failure sensors. Alternatively, the variable valves 411 and 431 may include an added feature of automatically reverting to an open state in the event of a grid power failure. Alternatively, a smaller jump-start valve could be added to the bottom of the battery stack(s) 405 that only opens in the event of a grid power failure to initiate a small flow of electrolyte. Alternatively, the variable valves 411 and 431 may be manually operated. Depending on embodiment, other arrangements are equally available, such as those that require very little power to provide black start operational capability.

During normal operation of a VRFB the electrolytes may pass through the battery stack(s) several times to reach the charged state or discharged state. During one pass through the battery stack(s) only a portion of the vanadium ions are able to react with their counterparts through the respective membranes within the battery stack(s). During the next pass through the battery stack(s) the reactants have been depleted from the previous pass and therefore fewer reactions take place. This behavior can be somewhat alleviated by increasing the pumping speed, or electrolyte flow rate, during each succeeding pass. But these techniques may be limited. An engineering rule of thumb is that it may be only practical to charge up a flow battery to an 80/20 SOC and likewise discharge the flow battery down to a 20/80 SOC, though embodiments are not limited to the same. The number of passes required to go from a 20/80 discharge state to an 80/20 charged state varies greatly according to a number of flow battery parameters such as voltages, temperature, flow rates, etc. Generally an average of three passes of the electrolyte through the battery stack(s) would be sufficient to go from one charge state to the other.

Such a requirement that a RFB may have to circulate the electrolyte multiple times to reach its charged or discharged state may affect selection between the desired arrangements of components shown in FIGS. 3-8. The electrolyte circulation methods shown in FIGS. 3, 4, and 7 may not be affected by this requirement. But the RFB arrangements of FIGS. 5 and 6 may not operate at a useful efficiency if the electrolyte has to circulate multiple times. In the arrangement of FIG. 5, an additional storage tank may desirably be added to each side of the flow battery for each additional circulation pass the electrolyte has to make through the battery stack(s). In the arrangement of FIG. 6, an additional half-tank and divider may desirably be added for each additional pass that has to be made through the battery stack(s). In such alternative arrangements of the FIG. 5 and FIG. 6, additional booster and collection tanks and associated plumbing may also be added in accordance with above.

One or more embodiments should not be considered limited to the specific examples described herein, but rather should be understood to cover many example aspects of the invention. Various modifications, equivalent processes, as well as numerous structures and device substitutions are applicable and readily available.

In FIGS. 4-8, the booster tanks are illustrated as simple cylindrical tanks, perhaps holding a few hundred gallons of electrolyte, as only an example, resting on ground level, and having a bulbous protrusion on their tops to contain additional inert gas. The collection tanks are illustrated as being somewhat smaller in size than the booster tanks, holding perhaps a hundred gallons of electrolyte, as only an example, resting on ground level, and having a snorkel mechanism on top. However, it is not intended that these example booster and collection tanks be limited to the illustrated embodiments. Accordingly, the booster and collection tanks need not be cylindrical; they may be spherical, rectangular, or have any other symmetrical or non-symmetrical shape. They may be positioned horizontally or vertically. They need not be resting on the ground; they may instead be positioned above or below ground level. The tanks may have any volume and may be sized in accordance with the over-all size of the flow battery system and the designed battery flow rates. The inert gas at the tops of the booster tanks may be contained in a bulbous-like structure of any size or shape, or the tank may simply be extended at its top to accommodate a volume of inert gas. The inert gas may even be contained in a separate tank structure that communicates with the top of the booster tank. The inert gas at the tops of the collection tanks may be maintained at atmospheric pressure by a snorkel mechanism, which may also serve to isolate the inert gas from the surrounding atmosphere.

The snorkel may be a device made up of several simpler components and having a purpose of communicating a gas trapped within the system to the outside atmosphere under a number of constraints, as only an example. The snorkel may maintain the gas pressure inside the storage tank at a same pressure as the atmosphere outside the tank. The snorkel may allows contained system gasses to vent to the outside atmosphere if the relative internal gas pressures exceed a specified relative amount, while preventing outside atmospheric gases from ever entering the internal gas chambers, for example. This restriction may be imposed to prevent oxidation of the electrolyte by atmospheric oxygen. In one or more embodiments, the snorkel mechanism may add inert gas, such as nitrogen or argon, to the internal gas chamber from a pressurized tank in order to equalize pressure in the storage tank with the outside atmosphere. For the purpose of this description, air may be considered to be an inert gas if it does not oxidize or otherwise react with the contained electrolyte. The snorkel may also contain a membrane to allow the escape of hydrogen gas from the flow battery system to prevent an explosive buildup of this gas within the storage tanks. In one or more embodiments, the snorkel may allow internal gases to selectively communicate with the outside atmosphere using bladders, one-way-valves, gas regulators, membranes, solenoids valves, screens, and other commercial components familiar to those versed in the art. The snorkel mechanism may include a housing that prevents snow, ice, and rain; animals, birds and tree seeds; and other environmental conditions from entering its mechanism, or corroding its components, for example.

The booster and collection tanks may be made of high density polyethylene, lined metal, flexible rubber-coated fabric, or other acid resistant materials that can withstand the pressure and containment requirements. The plumbing and valves are usually fabricated from cross-linked polyethylene (PEX), or ethylene-propylene rubber (EPR), or the like. The booster and collection tanks may be self-supporting, or be mounted within a supporting structure. The tanks may generally be mounted on, or be surrounded by, a containment tray, or catch basin, or other approaches to prevent electrolyte leaks or spills from entering the environment. The bottoms of the tanks may funnel the fluids to the output plumbing, or be flat, or have any other shape determined by function or design of the embodiment. The booster and collection tanks may include heating elements or cooling means as required and may be housed outdoors or indoors. The tanks may have multiple input and output elements, access ports, viewing ports, sensor attachment elements, and other accessories related or not related to embodiments described herein. Depending on embodiment, several booster or collection tanks may be designed as a single multi-chambered structure to save space, or clustered together with other tanks or components. In one or more embodiments, tops of the storage tanks may be sealed, to prevent acid fumes from escaping into the environment, but the tops of the tanks may still be controlled to be at atmospheric pressure to prevent stress on the storage tanks during variations in atmospheric pressure.

In a very large two-tank battery system embodiment, for example, there may be more than one electrolyte storage tank containing positive electrolyte and more than one electrolyte storage tank containing negative electrolyte with associated valves and plumbing. Accordingly, in such very large systems, several booster tanks and/or several collection tanks, may take the place of each or any one booster or collection tank shown in the illustrated embodiments. Likewise in a four-tank flow battery system there may be multiple storage tanks of each electrolyte type, negative and positive electrolyte, and depleted and charged electrolyte with associated extensions of the plumbing and valves to accommodate switching from storage tank to storage tank during battery operation.

In one or more embodiments, most or all of the valves and pumps may be computer controlled by a device or devices referred to herein as the “controller”. In one or more embodiments, the controller may be used to time and activate, as necessary, the various pumps and valves described herein. However, embodiments also include manual operation, remote operation, mechanical activation, or any other mechanism of controlling the pumps, valves, and/or other devices and actions that may be controlled and implemented. In a large scale redox flow battery embodiment, for example, a small computer, or controller, receives information from a variety of sensors, such as demonstrated in FIG. 8, processes the information through its internal algorithms, and then sends commands to control the pumps, valves, and other components of the flow battery. The controller may include a microcontroller or processor. Variable valves may be valves whose throat can be opened any amount from wide open to completely off, as only examples, and are used in the flow battery to regulate the amount of flow passing through a pipe, for example. In an embodiment, for example, three-port fluid control valves may be used to switch the flow of electrolyte between two components of the flow battery by way of the controller. In addition, in one or more embodiments, all valves leading into the battery stack(s) may be designed to introduce minimum turbulence into the electrolyte flow.

The arrangement of components shown FIGS. 3-8, and expressed in the corresponding descriptions, generally discuss or represent symmetry between the positive and negative sides of the flow battery system. However, the different reactant chemistry on each side of the flow battery may make it advantageous to employ different methods of distributing the electrolyte on the two sides of the flow battery. The quantity of positive electrolyte may differ from the negative electrolyte necessitating a difference in scale between the two sides of the flow battery. For these and other possible reasons, depending on embodiment, the design of the flow battery may be asymmetric. In any case, the teachings herein may be applied to any asymmetric battery arrangement, of any workable size, scale, or configuration as appropriate and depending on embodiment.

The illustrations of FIGS. 3-8 show a simple possible arrangement of the plumbing for transporting electrolyte through the battery stack(s), and battery components not necessary to an understanding of the embodiments herein have generally been omitted. For example, the plumbing connecting the electrolyte storage tanks to the battery stack(s) is shown in its most simple form in FIGS. 3-8 to enhance clarity of understanding of the flow paths. However, in actual implemented flow battery system embodiments, the plumbing would likely be more complex. In addition to an example minimum number of pumps and valves shown in FIGS. 3-8, actual systems may likely include additional pumps, additional safety and control valves, one-way valves, heat exchangers, sensor and sample access means, viewing ports, redundant and alternative flow paths, clean-out ports, disconnect unions, filtering means, venting means, and other components not directly necessary to an understanding of embodiments of the present invention. In one or more embodiments, the three-port valves may be hydraulic, pneumatic, manual, solenoid, motor controlled, or of whatever other type of valve that serves the function of the corresponding embodiment. The pipes and other plumbing components may be made of plastic, glass, metal, or other suitable acid-resistant materials, as only examples. As noted above, a large flow battery system embodiment may contain hundreds of battery stacks that may be generally mounted on metal racks, in which each rack may contain several shelves at different heights. The racks may generally be fabricated out of steel, but could be made of wood, plastic, or other suitable materials, as only examples. The mounting racks may generally include mechanisms to secure the racks, such as to bolt the racks to a floor; mounting mechanisms for the tubes, pipes, wires, and the like; and mounting mechanisms for sensors, controllers, valves, switches, and the like. Individual racks may be attached together to form a three dimensional matrix of shelving for the support of many battery stacks. The storage racks may be mounted in a catch basin or tray to contain electrolyte spills, as only examples.

In one or more embodiments, the example concepts of the flow battery systems described herein include all types of flow batteries such as iron/tin, iron/titanium, iron/chrome, sodium/bromine, zinc/bromine, and other possible reactant couples. One or more embodiments include an all vanadium flow battery (where the positive reactant couple is VO₂⁺/VO²⁺ and the negative couple is V³⁺/V²⁺), and the all chrome redox battery (where the positive couple is Cr⁵⁺/Cr⁴⁺ and the negative couple is Cr³⁺/Cr²⁺), and other single element redox flow batteries.

Again, as noted above, with regard to the embodiments of FIGS. 3-8, a sufficient pressure may be generated in the electrolyte that is provided to the battery stack(s) to ensure that the provided electrolyte flows through the battery stack(s). For example, in one or more embodiments, no pump is needed to force electrolyte through the battery stack(s), while also enabling the positive and negative electrolyte storage tanks to reside at ground level, or near ground level. However, in conventional gravity feed flow battery systems, where such a feeding pump may also not be necessary, it was undesirably necessary to elevate the storage tanks above the battery stack(s), which became difficult and dangerous because of the large volumes of electrolyte acid solution. Thus, if a large gravity feed flow battery were previously desired, e.g., a flow battery with a capacity for storing 1 megawatt of electric energy, it would have been necessary to elevate over 10 thousand gallons of an acid electrolyte solution, above the battery stack(s), such as shown in FIG. 2. However, as demonstrated in one or more embodiments herein, when the storage tank or booster tanks are sufficiently pressurized it is no longer necessary to elevate the storage tank, nor the introduced booster tanks. Accordingly, as an embodiment, using the above example implementation for a flow battery with a 1 Megawatt capacity, if the electrolyte acid solution is a vanadium electrolyte, with an example of 1.54 molar vanadium in a 2.0 molar sulfuric acid solution in water, or potentially an acid mix that uses 3-4 molar sulfuric acid, then 13,200 gallons of the vanadium electrolyte may be used to store 1 megawatt of electric energy. In such an embodiment, three cycles or passes of the electrolyte through the battery stack(s) may be desired to fully charge or discharge the flow battery, and some 19,800 gallons of electrolyte may thus travel through the battery stack(s) on both positive and negative sides. Here, for this example charging or discharging, the flow rate could then be 19,800 gallons per hour, or 330 gallons per minute, on each side of the battery stack(s), for example. In such an example, there may be an example 120 individual battery stacks, so that when charging or discharging, the flowing electrolyte is routed by internal and/or external plumbing to flow at a same rate for each battery stack, so the flow rate would be 2.75 gallons per minute per battery stack. As only an example, the configuration of FIG. 7 may result in equal flow rates for each battery stack, though alternate embodiments are also available, again, without requiring elevation of the positive and negative electrolyte storage tanks and reinforcing a laminar flow of electrolyte into the battery stack(s), e.g., through isolation of the pumping of the transported electrolyte from bottom or inlet of the battery stack(s).

While aspects of the present invention has been particularly shown and described with reference to differing embodiments thereof, it should be understood that these embodiments should be considered in a descriptive sense only and not for purposes of limitation. Descriptions of features or aspects within each embodiment should typically be considered as available for other similar features or aspects in the remaining embodiments. Suitable results may equally be achieved if the described techniques are performed in a different order and/or if components in a described system, architecture, device, or circuit are combined in a different manner and/or replaced or supplemented by other components or their equivalents.

Thus, although a few embodiments have been shown and described, with additional embodiments being equally available, it would be appreciated by those skilled in the art that changes may be made in these embodiments without departing from the principles and spirit of the invention, the scope of which is defined in the claims and their equivalents.

What is claimed is:

1. A flow battery system comprising:
a first battery stack including a first half-cell utilizing a liquid electrolyte;
a first pressure feed system, including at least a first storage tank and a first booster tank, designed to generate a first booster pressure in the first booster tank for the liquid electrolyte in the first booster tank sufficient to force the liquid electrolyte to be fed from the first pressure feed system through the first half-cell; and
a return system to return the liquid electrolyte from the first half-cell to the first pressure feed system.

2. The flow battery system of claim 1, wherein the first pressure feed system feeds the liquid electrolyte from the first booster tank to the first battery stack without using a pump.

3. The flow battery system of claim 1, further comprising a controller to control the first booster pressure of the liquid electrolyte in the first booster tank to generate the sufficient first booster pressure in the first booster tank.

4. The flow battery system of claim 3, wherein the controller controls a transporting of the liquid electrolyte, having transported from the first storage tank, to the first booster tank, such that the controlling of the transporting of the liquid electrolyte to the first booster tank controls the first booster pressure of the liquid electrolyte in the first booster tank to generate the sufficient first booster pressure in the first booster tank.

5. The flow battery system of claim 4, further comprising a pressure sensor configured to detect the first booster pressure of the liquid electrolyte in the first booster tank and the controller controls the transporting of the liquid electrolyte to the first booster tank based upon the detected first booster pressure.

6. The flow battery system of claim 5, wherein the first booster tank includes an inlet and the first pressure feed system further comprises a gas regulator to control an input of gas into the first booster tank through the inlet, and wherein the controller controls the gas regulator and the transporting of the liquid electrolyte to the first booster tank based upon the detected first booster pressure so that pressure provided to the first booster tank by the transporting of the liquid electrolyte to the first booster tank and pressure provided by the input gas generate the sufficient first booster pressure.

7. The flow battery system of claim 6, wherein the controller further selectively adjusts the generated sufficient first booster pressure based upon a determined electrolyte reactant imbalance.

8. The flow battery system of claim 6, further comprising a first booster tank pressure sensor to detect the first booster pressure, a temperature sensor in at least one of the first booster tank and the first storage tank, and a state of charge (SOC) detector to determine a state of charge of the electrolyte stored in at least one of the first booster tank and the first storage tank, and the controller determines the sufficient first booster pressure based upon determined results of the first booster tank pressure sensor, the temperature sensor, and the state of charge detector to generate a desired electrolyte flow rate through the first battery stack.

9. The flow battery system of claim 5, wherein the first booster tank internally comprises a pressure altering regulator configured to alter pressure within the first booster tank, and wherein the controller controls the pressure altering regulator and the transporting of the liquid electrolyte to the first booster tank based upon the detected first booster pressure to generate the sufficient first booster pressure.

10. The flow battery system of claim 9, wherein the controller further selectively adjusts the generated sufficient first booster pressure based upon a determined electrolyte reactant imbalance.

11. The flow battery system of claim 3, wherein the first booster tank internally comprises a pressure altering regulator configured to alter pressure within the first booster tank, and wherein the controller controls the pressure altering regulator based upon a detected pressure inside the first booster tank in the generating of the sufficient first booster pressure.

12. The flow battery system of claim 3, wherein the first booster tank includes an inlet and the first pressure feed system further comprises a gas regulator to control an input of gas into the first booster tank through the inlet, and wherein the controller controls the gas regulator based upon a detected pressure inside the first booster tank so that pressure provided to the first booster tank by the input gas generates the sufficient first booster pressure.

13. The flow battery system of claim 3, further comprising a variable valve in a fluid transport path of the liquid electrolyte being fed from the first pressure feed system to the first battery stack,
wherein the controller controls a variable opening of the variable valve to control a flow rate of the liquid electrolyte through the first battery stack when charging or discharging through battery cells of the first battery stack dependent on a determination of the first booster pressure.

14. The flow battery system of claim 3, further comprising a first booster tank pressure sensor to detect the first booster pressure, a temperature sensor in at least one of the first booster tank and the first storage tank, and a state of charge (SOC) detector to determine a state of charge of the electrolyte stored in at least one of the first booster tank and the first storage tank, and the controller determines the sufficient first booster pressure based upon determined results of the first booster tank pressure sensor, the temperature sensor, and the state of charge detector to generate a desired electrolyte flow rate through the first battery stack.

15. The flow battery system of claim 1, wherein the return system includes a gravity return system, such that the liquid electrolyte is fed into a first collection tank after having exited the first half-cell without using a pump and then selectively returned from the first collection tank to the first storage tank.

16. The flow battery system of claim 15, wherein the return system further comprises a return pump to pump the liquid electrolyte from the first collection tank to the first storage tank.

17. The flow battery system of claim 1, wherein the first pressure feed system further comprises a first booster tank pump to pump the liquid electrolyte, having transported from the first storage tank, to the first booster tank.

18. The flow battery system of claim 17, further comprising a controller to control the first booster tank pump to pump the liquid electrolyte with a selectable pressure to generate the sufficient first booster pressure.

19. The flow battery system of claim 18, wherein the controller controls a pumping of the first booster tank pump to increase a pumping pressure of the liquid electrolyte, having transported from the first storage tank, when the controller determines that the first booster pressure in the first booster tank is below a predetermined pressure.

20. The flow battery system of claim 18, wherein the controller controls a pumping of the first booster tank pump to decease a pumping pressure of the liquid electrolyte, having transported from the first storage tank, when the controller determines that the first booster pressure in the first booster tank is above a predetermined pressure.

21. The flow battery system of claim 1, wherein the sufficient first booster pressure is a pressure inside the first booster tank that generates a head pressure at the first battery stack that is greater than a minimum head pressure needed to force the liquid electrolyte to be fed through the first battery stack.

22. The flow battery system of claim 1, wherein a top of the first storage tank is fitted with a snorkel configured to equalize pressures inside a top-most portion of the first storage tank with an atmospheric pressure existing outside the first storage tank.

23. The flow battery system of claim 1, wherein a top portion of the first booster tank has an extended bulbous cavity above a electrolyte fluid level in the first booster tank for buffering changes in the first booster pressure in the first booster tank.

24. The flow battery system of claim 1, further comprising a second battery stack, including a second half-cell, at a height different from a height of the first battery stack, and
wherein the first pressure feed system further includes a second booster tank, designed to generate a second booster pressure in the second booster tank for the liquid electrolyte in the second booster tank sufficient to force the liquid electrolyte to be fed from the first pressure feed system through the second half-cell.

25. The flow battery system of claim 24, wherein the first pressure feed system feeds the liquid electrolyte from the first booster tank to the first battery stack without using a pump, and feeds the liquid electrolyte from the second booster tank to the second battery stack without using a pump.

26. The flow battery system of claim 25, further comprising a controller to control the first booster pressure in the first booster tank to generate the sufficient first booster pressure to force the liquid electrolyte to be fed from the first pressure feed system through the first half-cell when charging or discharging battery cells of the first battery stack, and to control the second booster pressure in the second booster tank to generate the sufficient second booster pressure to force the liquid electrolyte to be fed from the first pressure feed system through the second half-cell when charging or discharging battery cells of the second battery stack.

27. The flow battery system of claim 26,
wherein the controlling of the first booster pressure in the first booster tank includes a controlling of a transporting of the liquid electrolyte, having transported from the first storage tank, to the first booster tank based upon a determination of the first booster pressure so as to generate the sufficient first booster pressure, and
wherein the controlling of the second booster pressure in the second booster tank includes a controlling of a transporting of the liquid electrolyte, having transported from the first storage tank, to the second booster tank based upon a determination of the second booster pressure so as to generate the sufficient second booster pressure.

28. The flow battery system of claim 24, further comprising:
a first variable valve in a fluid transport path of the liquid electrolyte being fed from the first pressure feed system to the first battery stack;
a second variable valve in a fluid transport path of the liquid electrolyte being fed from the first pressure feed system to the second battery stack; and
wherein the controller controls a variable opening of the first variable valve based on a determination of the first booster pressure and controls a variable opening of the second variable valve based on a determination of the second booster pressure, to control respective flow rates of the liquid electrolyte through the first battery stack and the second battery stack when respectively charging or discharging.

29. The flow battery system of claim 24, wherein the return system includes a gravity return system, such that the liquid electrolyte is fed into one or more storage collection tanks after having exited the first half-cell without using a pump and after having exited the second half-cell without using a pump, and wherein the return system is configured to return the liquid electrolyte in the one or more storage collection tanks to the first storage tank.

30. The flow battery system of claim 24, wherein the first pressure feed system further comprises:
a first booster tank pump to pump the liquid electrolyte from the first storage tank to the first booster tank to adjust the first booster pressure in the first booster tank based on a determination of the first booster pressure, to generate the sufficient first booster pressure; and
a second booster tank pump to pump the liquid electrolyte from the first storage tank to the second booster tank to adjust the second booster pressure in the second booster tank based on a determination of the second booster pressure, to generate the sufficient first booster pressure.

31. The flow battery system of claim 30, wherein the controller controls the first booster tank pump to generate the sufficient first booster pressure based upon the determined first booster pressure, and controls the second booster tank pump to generate the sufficient second booster pressure based upon the determined second booster pressure.

32. The flow battery system of claim 24, wherein the first booster tank and the second booster tank are separate chambers of a single tank.

33. The flow battery system of claim 1, further comprising a second battery stack, including a second half-cell, at a height different from a height of the first battery stack, and
wherein the first booster tank includes a first outlet and a second outlet at different heights of the first booster tank, such that the first pressure feed system generates the first booster pressure sufficient to force the liquid electrolyte to be fed out of the first booster tank through the first outlet and then through the first half-cell, and sufficient to force the liquid electrolyte to be fed out of the first booster tank through the second outlet and then through the second half-cell.

34. The flow battery system of claim 1, wherein the first storage tank is configured to separately store charged liquid electrolyte in a first portion of the first storage tank and depleted liquid electrolyte in a second first portion of the first storage tank, with the first portion and the second portion being dynamically defined based upon a variable movement of a separator of the first storage tank performing the separate storing of the charged liquid electrolyte and the depleted liquid electrolyte.

35. The flow battery system of claim 34, wherein the first pressure feed system further comprises a second booster tank, and the first pressure feed system is designed to generate a second booster pressure in the second booster tank for the liquid electrolyte in the second booster tank sufficient to force the liquid electrolyte to be fed from the second pressure feed system through the first half-cell, and
wherein the first pressure feed system is further configured to transport the charged liquid electrolyte to the first booster tank, having transported from the first portion of the first storage tank, and to transport the depleted liquid electrolyte to the second booster tank, having transported from the second portion of the first storage tank.

36. The flow battery system of claim 35, further comprising:
a charge/discharge selector valve in a fluid transport path of the charged liquid electrolyte being fed from the first booster tank to the first battery stack and in a fluid transport path of the depleted liquid electrolyte being fed from the second booster tank to the first battery stack; and
a variable valve in a transport fluid path of the charged or depleted liquid electrolyte having passed the charge/discharge selector valve to the first battery stack,
wherein the controller controls a respective variable opening of the variable valve to control a flow rate of the charged or depleted liquid electrolyte through the first battery stack when respectively charging or discharging, and controls the charge/discharge valve to transport the charged liquid electrolyte from the first booster tank to the first battery stack when discharging the first battery stack and to transport the depleted liquid electrolyte from the second booster tank to the first battery stack when charging the first battery stack.

37. The flow battery system of claim 1, further comprising a second pressure feed system including at least a second storage tank and second booster tank,
such that the second pressure feed system is designed to generate a second booster pressure in the second booster tank for the liquid electrolyte in the second booster tank sufficient to force the liquid electrolyte to be fed from the second pressure feed system through the first half-cell.

38. The flow battery system of claim 37, wherein the liquid electrolyte stored by the first storage tank is charged liquid electrolyte and the liquid electrolyte stored by the second storage tank is depleted liquid electrolyte.

39. The flow battery system of claim 38, further comprising a controller to control a transporting of the charged liquid electrolyte from the first storage tank to the first booster tank to generate the sufficient first booster pressure in the first booster tank, to force the liquid electrolyte to be fed from the first pressure feed system through the first half-cell when discharging battery cells of the first battery stack, and to control a transporting of the depleted liquid electrolyte from the second storage tank to the second booster tank to generate the sufficient second booster pressure in the second booster tank, to force the liquid electrolyte to be fed from the second pressure feed system through the first half-cell when charging battery cells of the first battery stack.

40. The flow battery system of claim 39, further comprising:
a charge/discharge selector valve in a fluid transport path of the charged liquid electrolyte being fed from the first pressure feed system to the first battery stack and in a fluid transport path of the depleted liquid electrolyte being fed from the second pressure feed system to the first battery stack; and
a variable valve in a transport fluid path of the charged or depleted liquid electrolyte having passed the charge/discharge selector valve to the first battery stack,
wherein the controller controls a respective variable opening of the variable valve to control a flow rate of the charged or depleted liquid electrolyte through the first battery stack when respectively charging or discharging based on a determination of the first booster pressure or the second booster tank pressure, and controls the charge/discharge valve to transport charged liquid electrolyte from the first pressure feed system to the first battery stack when discharging the first battery stack and to transport depleted liquid electrolyte from the second pressure feed system to the first battery stack when charging the first battery stack.

41. The flow battery system of claim 38, wherein the return system includes a gravity return system, such that the charged liquid electrolyte is selected to be fed into a first collection tank after having been charged and then exited the first half-cell without using a pump and then selectively returned from the first collection tank to the first storage tank, and the depleted liquid electrolyte is selected to be fed into a second collection tank after having been depleted and then exited the first half-cell without using a pump and then selectively returned from the second collection tank to the second storage tank.

42. The flow battery system of claim 38, wherein the first pressure feed system further comprises a first booster tank pump to pump charged liquid electrolyte from the first storage tank to the first booster tank to adjust the first booster pressure in the first booster tank based on a determination of the first booster pressure, and wherein the second pressure feed system further comprises a second booster tank pump to pump depleted liquid electrolyte from the second storage tank to the second booster tank to adjust the second booster pressure in the second booster tank based on a determination of the second booster pressure.

43. The flow battery system of claim 37, further comprising a pressure equilibrium element connecting a gas space in the first storage tank and a gas space in the second storage tank, configured to perform equilibrium between an atmospheric pressure and the gas spaces in the first and second storage tanks.

44. The flow battery system of claim 37, wherein the first booster tank and the second booster tank are separate chambers of a single tank.

45. The flow battery system of claim 1, wherein the sufficiency of the first booster pressure in the first booster tank, to force the liquid electrolyte to be fed through the first half-cell, is based on a configuration of the first battery stack having an inlet fed the liquid electrolyte from the first pressure feed system and/or an outlet to return the liquid electrolyte to the return system be on lateral sides of the first battery stack.

46. The flow battery system of claim 1, wherein the sufficiency of the first booster pressure in the first booster tank, to force the liquid electrolyte to be fed through the first half-cell, is based on a configuration of the first battery stack having an inlet fed the liquid electrolyte from the first pressure feed system and/or an outlet to return the liquid electrolyte to the return system be on top or bottom sides of the first battery stack.

47. A flow battery system, comprising:
a battery stack including a battery cell, half of the battery cell being a half-cell utilizing positive terminal liquid electrolyte and another half of the battery cell being a second half-cell utilizing a negative terminal liquid electrolyte;
a first feed system, including at least a first storage tank for storing the positive terminal liquid electrolyte, designed to force the positive terminal liquid electrolyte to be fed from the first feed system through the first half-cell;
a second feed system, including at least a second storage tank for storing the negative terminal liquid electrolyte, designed to force the negative terminal liquid electrolyte to be fed from the second feed system through the second half-cell;
a first return system to return the positive terminal liquid electrolyte from the first half-cell to the first storage tank of the first pressure feed system; and
a second return system to return the negative terminal liquid electrolyte from the second half-cell to the second storage tank of the first pressure feed system,
wherein the first and second return systems include gravity return systems, such that the positive terminal liquid electrolyte is fed into a first collection tank after having exited the first half-cell without using a pump and then selectively returned from the first collection tank to the first storage tank, and the negative terminal liquid electrolyte is fed into a second collection tank after having exited the second half-cell without using a pump and then selectively returned from the second collection tank to the second storage tank.

48. A flow battery system, comprising:
a battery stack including a battery cell, half of the battery cell being a half-cell utilizing positive terminal liquid electrolyte and another half of the battery cell being a second half-cell utilizing a negative terminal liquid electrolyte;
a first pressure feed system, including at least a first storage tank and a first booster tank for storing the positive terminal liquid electrolyte, designed to generate a first booster pressure in the first booster tank for the positive terminal liquid electrolyte in the first booster tank sufficient to force the positive terminal liquid electrolyte to be fed from the first booster tank through the first half-cell;
a second pressure feed system, including at least a second storage tank and a second booster tank for storing the negative terminal liquid electrolyte, designed to generate a second booster pressure in the second booster tank for the negative terminal liquid electrolyte in the second booster tank sufficient to force the negative terminal liquid electrolyte to be fed from the second booster tank through the second half-cell;
a first return system to return the positive terminal liquid electrolyte from the first half-cell to the first storage tank of the first pressure feed system; and
a second return system to return the negative terminal liquid electrolyte from the second half-cell to the second storage tank of the first pressure feed system.

49. The flow battery system of claim 48, wherein the first pressure feed system feeds the positive terminal liquid electrolyte from the first booster tank to the first half cell without using a pump, and the second pressure feed system feeds the negative terminal liquid electrolyte from the second booster tank to the second half cell without using a pump.

50. The flow battery system of claim 49, further comprising a controller to control the first booster pressure in the first booster tank to be the sufficient first booster pressure, by controlling a transporting pressure of the positive terminal liquid electrolyte from the first storage tank to the first booster tank, to force the positive terminal liquid electrolyte to be fed from the first booster tank through the first half-cell, and to control the second booster pressure in the second booster tank to be the sufficient second booster pressure, by controlling a transporting pressure of the negative terminal liquid electrolyte from the second storage tank to the second booster tank, to force the negative terminal liquid electrolyte to be fed from the second booster tank through the second half-cell.

51. The flow battery system of claim 50, wherein the sufficient first booster pressure is equal to the sufficient second booster pressure.

52. The flow battery system of claim 50, wherein the sufficient first booster pressure is different from the sufficient second booster pressure, and the controller controls a flow rate of the positive terminal liquid electrolyte through the first half-cell to be different from a controller controlled flow rate of the negative terminal liquid electrolyte through the second half-cell.

53. The flow battery system of claim 48, wherein the first and second return systems include gravity return systems, such that the positive terminal liquid electrolyte is fed into a first collection tank after having exited the first half-cell without using a pump and then selectively returned from the first collection tank to the first storage tank, and the negative terminal liquid electrolyte is fed into a second collection tank after having exited the second half-cell without using a pump and then selectively returned from the second collection tank to the second storage tank.

54. A flow battery control method of a flow battery system including a first battery stack including a first half-cell utilizing a liquid electrolyte, a first pressure feed system including at least a first storage tank and a first booster tank, and a return system to return the liquid electrolyte from the first half-cell to the first pressure feed system, the method comprising:
controlling a transportation of the liquid electrolyte in the first storage tank to the first booster tank;
controlling a first booster pressure of the liquid electrolyte in the first booster tank to generate a sufficient first booster pressure in the first booster tank to force the liquid electrolyte to be fed from the first pressure feed system through the first half-cell when charging or discharging battery cells of the first battery stack; and
controlling a feeding of the liquid electrolyte from the first pressure feed system to the first battery stack, to control a flow rate of the liquid electrolyte through the first battery stack when charging or discharging through battery cells of the first battery stack.

55. The flow battery control method of claim 54, further comprising controlling the return system of the flow battery system to transport the liquid electrolyte, after having exited the first battery stack, to one or more collection tanks using gravity feed without a pump, and controlling the return system of the flow battery system to transport the liquid electrolyte in the collection tank to the first storage tank.

56. The flow battery control method of claim 54, further comprising controlling the first pressure feed system to feed the liquid electrolyte from the first booster tank to the first battery stack without using a pump.

57. The flow battery control method of claim 54, wherein the controlling of the variable feeding of the liquid electrolyte is performed by controlling a variable opening of a variable valve, in a fluid transport path of the liquid electrolyte from the first pressure feed system to the first battery stack, and the variable feeding controls a flow rate of the liquid electrolyte in the first battery stack based on a determination of the first booster pressure.

58. The flow battery control method of claim 54, wherein the controlling of the first booster pressure in the first booster tank is performed by controlling a booster tank pump, arranged in a fluid transport path between the first storage tank and the first booster tank, to selectively transport the fluid electrolyte from the first storage tank to the first booster tank with a pressure controlled to generate the sufficient first booster pressure in the first booster tank.

59. The flow battery control method of claim 54, wherein the flow battery system further comprises a first booster tank pressure sensor to detect the first booster pressure, a temperature sensor in at least one of the first booster tank and the first storage tank, and a state of charge (SOC) detector to determine a state of charge of the electrolyte stored in at least one of the first booster tank and the first storage tank, and wherein the method further comprises determining the sufficient first booster pressure based upon determined results of the first booster tank pressure sensor, the temperature sensor, and the state of charge detector to generate a desired electrolyte flow rate through the first battery stack.

60. The flow battery control method of claim 54, wherein the flow battery system further includes a second battery stack, including a second half-cell, at a height different from a height of the first battery stack, and a second booster tank, and the method further comprises:
controlling a transportation of the liquid electrolyte in the first storage tank to the second booster tank;
controlling a second booster pressure of the liquid electrolyte in the second booster tank to generate a sufficient second booster pressure in the second booster tank to force the liquid electrolyte to be fed from the first pressure feed system through the second half-cell when charging or discharging battery cells of the second battery stack;
controlling the first booster pressure in the first booster tank to be the sufficient first booster pressure based upon a controlled pressure produced by the controlling of the transportation of the liquid electrolyte in the first storage tank to the first booster tank; and
controlling the second booster pressure in the second booster tank to be the sufficient second booster pressure based upon a controlled pressure produced by the controlling of the transportation of the liquid electrolyte in the first storage tank to the second booster tank.

61. The flow battery control method of claim 54, wherein the flow battery system further includes a second pressure feed system, including a second storage tank and second booster tank, liquid electrolyte stored by the first storage tank is charged liquid electrolyte and liquid electrolyte stored by the second storage tank is depleted liquid electrolyte, and the method further comprises:
controlling a transportation of the liquid electrolyte in the second storage tank to the second booster tank;
controlling a second booster pressure of the liquid electrolyte in the second booster tank to generate a sufficient second pressure in the second booster tank to force the liquid electrolyte to be fed from the second pressure feed system through the first half-cell when charging battery cells of the first battery stack;
controlling the first booster pressure in the first booster tank to be the sufficient first booster pressure based upon a controlled pressure produced by the controlling of the transportation of the liquid electrolyte in the first storage tank to the first booster tank; and
controlling the second booster pressure in the second booster tank to be the sufficient second booster pressure based upon a controlled pressure produced by the controlling of the transportation of the liquid electrolyte in the second storage tank to the second booster tank.
